(19) United States
(12) Patent Application Publication
(10) Pub. No.: US 2024/0388379 A1
(43) Pub. Date: Nov. 21, 2024

(54) METHODS AND APPARATUSES FOR NETWORK CODING-BASED HARQ RETRANSMISSION WITH SCRAMBLING

(71) Applicant: HUAWEI TECHNOLOGIES CO., LTD., Shenzhen (CN)

(72) Inventors: Yu CAO, Kanata (CA); Jianglei MA, Kanata (CA)

(21) Appl. No.: 18/774,204

(22) Filed: Jul. 16, 2024

Related U.S. Application Data
(63) Continuation of application No. PCT/CN2022/073281, filed on Jan. 21, 2022.

(51) Int. Cl. H04L 1/00; H04L 1/08; H04W 72/044; H04W 72/231

(52) U.S. Cl. CPC H04L 1/0011; H04L 1/08; H04W 72/0466; H04W 72/231

(57) ABSTRACT

Methods and apparatuses for network coding with a retransmission scheme are described. A first packet intended for a first destination node and a second packet intended for a second destination node are obtained. An initial transmission of the first packet to the first and second destination nodes is performed, and an initial transmission of the second packet to the first and second destination nodes is performed. A retransmission to the first and the second destination nodes is performed, where performing the retransmission includes generating cross-packet coded bits using a combination of one or more bits from the first packet and one or more bits from the second packet, where the cross-packet coded bits are scrambled using an identifier known to both the first and second destination nodes, and where the cross-packet coded bits, after scrambling, are used for the retransmission.

### CROSS-REFERENCE TO RELATED APPLICATION

This application is a continuation of International Application No. PCT/CN2022/073281, filed on Jan. 21, 2022, the disclosure of which is hereby incorporated by reference in its entirety.

### FIELD

The present disclosure relates to the use of network coding in wireless communications, including retransmission schemes in network coding with the use of scrambling.

### BACKGROUND

Hybrid automatic repeat request (HARQ) is a commonly used retransmission technique for improving transmission reliability in wireless communication. In Long Term Evolution (LTE) transmissions, a transport block (TB) can be divided into multiple forward error correction (FEC) blocks (also referred to as code blocks (CBs)). However, HARQ retransmission is TB based. This means that if a receiving device has an error in decoding even one CB in the TB, and a retransmission request is sent back to the transmitting device, the transmitting device needs to retransmit the redundant versions of all the CBs in the TB, even though some of the CBs in the TB have been correctly received.

In New Radio (NR) release 15, code block group (CBG)-based HARQ retransmission is supported. In CBG-based HARQ retransmission, CBs are grouped in CBGs, and feedback from the receiving device includes the index of the CBG containing the CB that has an error in decoding. Then the retransmission can be based on only the one or more CBGs having the index indicated in the feedback, instead of retransmission based on the entire TB. However, CBG-based HARQ retransmission requires feedback to indicate the CBG index that needs to be retransmitted, which increases the overhead of the HARQ feedback. Furthermore, in the case where each CGB has one (or more) CB in error, all CBGs (i.e., the entire TB) are used for the retransmission; thus, there would be no savings in retransmission, in addition to the added overhead of having to feedback the CBG indexes.

Some HARQ retransmission schemes, such as cross-packet HARQ retransmission schemes, have been recently proposed, which may help to overcome some drawbacks of existing HARQ retransmission techniques. It would be useful to provide solutions that enable cross-packet HARQ retransmission to be used with network coding.

### SUMMARY

HARQ retransmission techniques have been recently proposed, in which retransmissions are based on check blocks generated from bits selected from across two or more code blocks. Such check blocks may be referred to as vertical check blocks or cross-CB check blocks, in some examples. The use of vertical check blocks in HARQ retransmission (which may be referred to as 2D HARQ) provides improvements in efficiency, because a retransmission with a single vertical check block provides information that can be used to help decoding across multiple CBs. Further, soft information from previous decoding attempts can be used to help later decoding attempts.

2D HARQ may be used together with network coding, to enable greater efficiency benefits. When vertical check blocks are used with network coding, a given vertical check block may be generated using bits selected from across two or more packets (which may be from a single TB or from multiple TBs). Such check blocks may be referred to as cross-packet check blocks, cross-TB check blocks or cross-packet vertical check blocks or cross-CB check blocks (where the CBs belong to multiple packets) (the present disclosure may use the term cross-packet vertical check block, which is intended to encompass other terms for such check blocks). Further, the use of cross-packet vertical check blocks in network coding may be referred to as 2D joint coding (where 2D refers to the generation of cross-packet vertical check blocks across two or more packets, in addition to horizontal check blocks in the case of systematic code; and joint coding refers to joint encoding of information from the two or more packets in the cross-packet vertical check blocks). Although the present disclosure describes examples where retransmissions are performed using cross-packet vertical check blocks, it should be understood that other coding schemes may be used for retransmission (i.e., the retransmissions are not necessarily limited to cross-packet vertical check blocks).

However, the use of 2D HARQ for network coding requires solutions that address the problem of how to ensure data privacy, as well as solutions that address the problem of how to signal control information.

In various examples, the present disclosure describes methods and apparatuses for physical (PHY) layer network coding using 2D HARQ retransmission, where scrambling is used to preserve data privacy. In particular, data privacy is preserved for each user equipment (UE) participating in the network coding because a UE-specific identifier, which is known only by the specific UE, is used to scramble UE-specific data that should be known only by that specific UE. At the same time, a network coding identifier, which is known to all UEs participating in a given network coding retransmission, is used to scramble the cross-packet vertical check blocks. In this way, all UEs can unscramble and use the retransmission data to help their own decoding attempts, but each UE is able to unscramble and access only its own UE-specific data. This provides the technical advantage that there is improved efficiency in retransmissions due to the use of cross-packet vertical check blocks, while data privacy is preserved for each UE.

In various examples, the present disclosure describes signaling mechanisms that can be used for semi-static configuration of UEs for network coding. The present disclosure also describes signaling mechanisms that can be used for dynamic scheduling of UEs for network coding. The present disclosure describes both semi-static and dynamic mechanisms to configure UEs for a network coding group, so that the configured UEs may participate in network coding within the network coding group. The network coding configurations may include information (e.g., a network coding identifier, which may be a network coding radio network temporary identifier (RNTI)) to enable each UE in the network coding group to unscramble information that has been scrambled using the network coding identifier (e.g., scrambled using the network coding identifier as a scrambling sequence or using a scrambling sequence that is a function of the network coding identifier). This provides mechanisms for configuring UEs so that UEs participating in the network coding are able to unscramble and make use of the retransmission data.

In some example aspects, the present disclosure describes a method, at a network node, including: obtaining a first packet intended for a first destination node and a second packet intended for a second destination node; performing an initial transmission of the first packet to the first and second destination nodes, and performing an initial transmission of the second packet to the first and second destination nodes; and performing a retransmission to the first and the second destination nodes, wherein performing the retransmission includes generating cross-packet coded bits using a combination of one or more bits from the first packet and one or more bits from the second packet, wherein the cross-packet coded bits are scrambled using an identifier known to both the first destination node and the second destination node, and wherein the cross-packet coded bits, after scrambling, are used for the retransmission.

In an example of the preceding example aspect of the method, generating the cross-packet coded bits may include generating a set of one or more cross-packet check blocks using the one or more bits from the first packet and one or more bits from the second packet.

In an example of any of the preceding example aspects of the method, the first destination node and the second destination node may be configured for network coding in a given network coding group, the cross-packet coded bits may be scrambled using a network coding identifier associated with the given network coding group, the network coding identifier being the identifier known to both the first destination node and the second destination node.

In an example of the preceding example aspect of the method, the cross-packet coded bits may be scrambled using a scrambling sequence that is a function of the network coding identifier.

In an example of any of the preceding example aspects of the method, the first and the second destination nodes may be provided configuration information for network coding in the given network coding group, the configuration information including the network coding identifier associated with the given network coding group.

In an example of the preceding example aspect of the method, the configuration information for the first destination node may further include a first node index assigned to the first destination node within the given network coding group, and the configuration information for the second destination node may further include a second node index assigned to the second destination node within the given network coding group.

In an example of the preceding example aspect of the method, the method may further include: scheduling the retransmission, wherein scheduling the retransmission includes providing control information to the first and second destination nodes, the control including the first and second node indexes as indicators that the first and second packets are source packets for the retransmission.

In an example of the preceding example aspect of the method, the control information for scheduling the retransmission may be transmitted to the first and the second destination nodes using a group common downlink control information (DCI) transmission, and the group common DCI may be addressed to the given network coding group using the network coding identifier.

In an example of any of the preceding example aspects of the method, the method may further include: transmitting configuration signals to provide the first and the second destination nodes with the configuration information for network coding in the given network coding group; and subsequent to transmitting the configuration signals, scheduling the initial transmission of the first packet and scheduling the initial transmission of the second packet.

In an example of the preceding example aspect of the method, the configuration signals may be radio resource control (RRC) signals transmitted to the respective first and second destination nodes, and control information for scheduling the initial transmission of the first packet and for scheduling the initial transmission of the second packet may be transmitted in group common downlink control information (DCI) transmissions addressed to the given network coding group using the network coding identifier.

In an example of any of the preceding example aspects of the method, the method may further include: scheduling the initial transmission of the first packet and scheduling the initial transmission of the second packet, wherein the configuration information to configure the first and the second destination nodes for network coding in the given network coding group are included in control information for scheduling the initial transmissions.

In an example of the preceding example aspect of the method, the control information for scheduling the initial transmission of the first packet and for scheduling the initial transmission of the second packet may be transmitted in user equipment (UE)-specific downlink control information (DCI) transmissions addressed to each of the first and the second destination nodes, wherein the configuration information to configure the first destination node for network coding in the given network coding group may be included in the UE-specific DCI transmission addressed to the first destination node, and wherein the configuration information to configure the second destination node for network coding in the given network coding group may be included in the UE-specific DCI transmission addressed to the second destination node.

In an example of any of the preceding example aspects of the method, prior to generating the cross-packet coded bits, the bits from the first packet may be scrambled using a UE-specific identifier associated with the first destination node and the bits from the second packet may be scrambled using a UE-specific identifier associated with the second destination node, and the cross-packet coded bits may be generated using the scrambled bits from the first packet and the scrambled bits from the second packet.

In an example of any of the preceding example aspects of the method, performing the initial transmission of the first packet may include: generating a set of codewords for the first packet; scrambling the set of codewords for the first packet using the network coding identifier; and transmitting the scrambled set of codewords for the first packet in the initial transmission of the first packet. Performing the initial transmission of the second packet may include: generating a set of codewords for the second packet; scrambling the set of codewords for the second packet using the network coding identifier; and transmitting the scrambled set of codewords for the second packet in the initial transmission of the second packet.

In an example of the preceding example aspect of the method, performing the initial transmission of the first packet may further include: scrambling information bits of the first packet using a UE-specific identifier associated with the first destination node; and processing the scrambled information bits of the first packet to generate the set of codewords for the first packet. Performing the initial transmission of the second packet may further include: scrambling information bits of the second packet using a UE-specific identifier associated with the second destination node; and processing the scrambled information bits of the second packet to obtain the set of codewords for the second packet.

In some example aspects, the present disclosure describes a method, at a destination node, including: receiving an initial transmission of a first packet intended for the destination node, the initial transmission including scrambled codewords for the first packet, wherein the scrambled codewords for the first packet are scrambled using a network coding identifier associated with a network coding group for which the destination node is configured; unscrambling the initial transmission of the first packet using the network coding identifier to unscramble the codewords for the first packet and attempting to recover information bits of the first packet; receiving an initial transmission of a second packet intended for a different destination node, the initial transmission including scrambled codewords for the second packet, wherein the scrambled codewords for the second packet are scrambled using a network coding identifier associated with a network coding group for which the destination node is configured; unscrambling the initial transmission of the second packet using the network coding identifier; receiving a retransmission including cross-packet coded bits generating from a combination of one or more bits from the first packet and one or more bits from the second packet; and unscrambling the retransmission using the network coding identifier, and using the cross-packet coded bits to assist in recovery of the information bits of the first packet.

In an example of the preceding example aspect of the method, the method may further include: after unscrambling the initial transmission of the first packet using the network coding identifier, attempting to decode the codewords for the first packet and unscrambling the information bits of the first packet using a user equipment (UE)-specific identifier associated with the destination node.

In an example of any of the preceding example aspects of the method, the method may further include: prior to receiving the initial transmission of the first packet and receiving the initial transmission of the second packet, receiving the configuration information including the network coding identifier.

In an example of any of the preceding example aspects of the method, the configuration information may be received in a radio resource control (RRC) signal.

In an example of the preceding example aspect of the method, the method may further include: receiving control information for scheduling the initial transmission of the first packet in a group common downlink control information (DCI) transmission addressed to the network coding group using the network coding identifier; and receiving control information for scheduling the initial transmission the second packet in another group common DCI transmission addressed to the network coding group using the network coding identifier.

In an example of any of the preceding example aspects of the method, the configuration information may be received in control information for scheduling the initial transmission of the first packet, and the control information for scheduling the initial transmission of the first packet may be received in a UE-specific downlink control information (DCI) transmission addressed to the destination node.

In some example aspects, the present disclosure describes an apparatus including a processing unit. The processing unit is configured to execute machine-readable instructions to cause the apparatus to perform any of the methods described above.

In an example of the preceding example aspect of the apparatus, the apparatus may be a base station.

In an example of the preceding example aspect of the apparatus, the apparatus may be a user equipment (UE).

In some example aspects, the present disclosure describes a computer readable medium having machine-executable instructions stored thereon. The instructions, when executed by a processing unit of an apparatus, cause the apparatus to perform the any of the methods described above.

### BRIEF DESCRIPTION OF THE DRAWINGS

Reference will now be made, by way of example, to the accompanying drawings which show example embodiments of the present application, and in which:

FIG. 1 is a schematic diagram of an example wireless communication system suitable for implementing examples described herein;

FIG. 2 is a block diagram showing an example apparatus suitable for implementing examples described herein;

FIG. 3A illustrates an example code structure for a single transport block (TB), including vertical check blocks;

FIG. 3B illustrates an example code structure for a single TB based on non-systematic code, including vertical check blocks;

FIG. 4 illustrates an example code structure for a multiple TBs, including cross-packet vertical check blocks;

FIG. 5 is an example dataflow illustrating use of a UE-specific identifier for scrambling in a conventional data transmission;

FIG. 6A is a flowchart illustrating an example method for performing initial transmission and retransmission, in accordance with examples disclosed herein;

FIG. 6B is a flowchart illustrating an example method, at a destination node, for receiving initial transmission and retransmission, in accordance with examples disclosed herein;

FIG. 7 is a flowchart illustrating an example method for performing an initial transmission using an example of two-level scrambling, as disclosed herein;

FIG. 8 is a flowchart illustrating an example method for performing a retransmission using an example of two-level scrambling, as disclosed herein;

FIG. 9 is a signaling diagram illustrating an example of semi-static configuration of a network coding group, as disclosed herein;

FIG. 10 is a signaling diagram illustrating an example of dynamic configuration of a network coding group, as disclosed herein; and

FIG. 11 is a flowchart illustrating an example method for configuring a network coding group and performing network coding-based (re) transmissions, as disclosed herein.

Similar reference numerals may have been used in different figures to denote similar components.

### DETAILED DESCRIPTION

To assist in understanding the present disclosure, an example wireless communication system is now described.

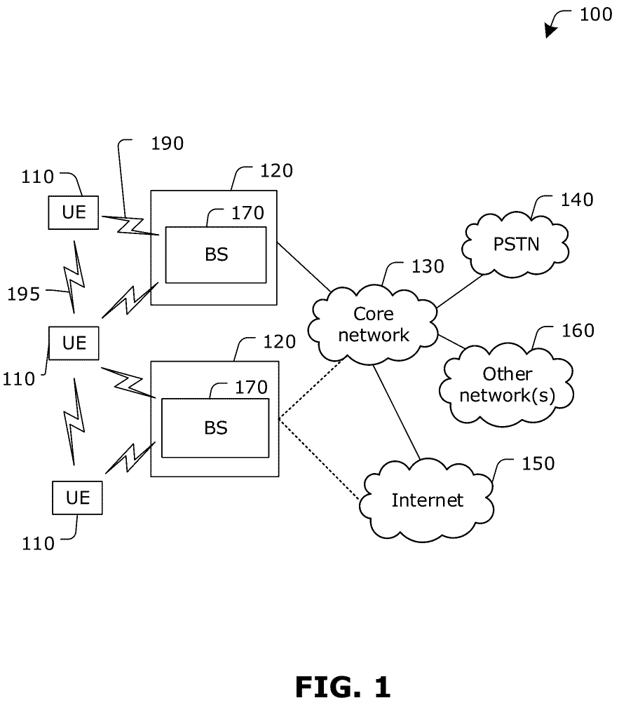

FIG. 1 illustrates an example wireless communication system 100 (also referred to as a wireless system 100) in which embodiments of the present disclosure could be implemented. In general, the wireless system 100 enables multiple wireless or wired elements to communicate data and other content. The wireless system 100 may enable content (e.g., voice, data, video, text, etc.) to be communicated (e.g., via broadcast, narrowcast, user device to user device, etc.) among entities of the system 100. The wireless system 100 may operate by sharing resources such as bandwidth. The wireless system 100 may be suitable for wireless communications using 5G technology and/or later generation wireless technology. In some examples, the wireless system 100 may also accommodate some legacy wireless technology (e.g., 3G or 4G wireless technology).

In the example shown, the wireless system 100 includes user equipment (UEs) 110, radio access networks (RANs) 120, a core network 130, a public switched telephone network (PSTN) 140, the internet 150, and other networks 160. In some examples, one or more of the networks may be omitted or replaced by a different type of network. Other networks may be included in the wireless system 100. Although certain numbers of these components or elements are shown in FIG. 1, any reasonable number of these components or elements may be included in the wireless system 100.

The UEs 110 are configured to operate, communicate, or both, in the wireless system 100. For example, the UEs 110 may be configured to transmit, receive, or both via wireless or wired communication channels. The term “UE” may be used to refer to any suitable end user device for wireless operation and may include such devices (or may be referred to) as a wireless transmit/receive unit (WTRU), a mobile station, a mobile relay, a fixed or mobile subscriber unit, a cellular telephone, a station (STA), a machine type communication (MTC) device, a personal digital assistant (PDA), a smartphone, a laptop, a computer, a tablet, a wireless sensor, an internet of things (IoT) device, a network-enabled vehicle, or a consumer electronics device, among other possibilities. In some examples, the term electronic device (ED) may be used instead of UE. In general, it should be understood that the use of the term UE in the present disclosure does not necessarily limit the present disclosure to any specific wireless technology.

In FIG. 1, the RANs 120 include base stations (BSs) 170. Although FIG. 1 shows each RAN 120 including a single respective BS 170, it should be understood that any given RAN 120 may include more than one BS 170, and any given RAN 120 may also include base station controller(s) (BSC), radio network controller(s) (RNC), relay nodes, elements, and/or devices. Each BS 170 is configured to wirelessly interface with one or more of the UEs 110 to enable access to any other BS 170, the core network 130, the PSTN 140, the internet 150, and/or the other networks 160. For example, the BSs 170 may also be referred to as (or include) a base transceiver station (BTS), a radio base station, a Node-B (NodeB), an evolved NodeB (eNodeB or eNB), a Home eNodeB, a gNodeB (gNB) (sometimes called a next-generation Node B), a transmission point (TP), a transmission/reception point (TRP), a site controller, an access point (AP), or a wireless router, among other possibilities. Future generation BSs 170 may be referred to using other terms. Any UE 110 may be alternatively or additionally configured to interface, access, or communicate with any other BS 170, the internet 150, the core network 130, the PSTN 140, the other networks 160, or any combination of the preceding. In some examples, a BS 170 may access the core network 130 via the internet 150.

The UEs 110 and BSs 170 are examples of communication equipment that can be used to implement some or all of the functionality and/or embodiments described herein. Any BS 170 may be a single element, as shown, or multiple elements, distributed in the corresponding RAN 120, or otherwise. Each BS 170 transmits and/or receives wireless signals within a particular geographic region or area, sometimes referred to as a “cell” or “coverage area”. A cell may be further divided into cell sectors, and a BS 170 may, for example, employ multiple transceivers to provide service to multiple sectors. In some embodiments there may be established pico or femto cells where the radio access technology supports such. A macro cell may encompass one or more smaller cells. In some embodiments, multiple transceivers could be used for each cell, for example using multiple-input multiple-output (MIMO) technology. The number of RANs 120 shown is exemplary only. Any number of RANs may be contemplated when devising the wireless system 100.

The BSs 170 communicate with one or more of the UEs 110 over one or more uplink (UL)/downlink (DL) wireless interfaces 190 (e.g., via radio frequency (RF), microwave, infrared, etc.). The UL/DL interface 190 may also be referred to as a UL/DL connection, UE-BS link/connection/interface, or UE-network link/connection/interface, for example. The UEs 110 may also communicate directly with one another (i.e., without involving the BS 170) via one or more sidelink (SL) wireless interfaces 195. The SL interface 195 may also be referred to as a SL connection, UE-to-UE link/connection/interface, vehicle-to-vehicle (V2V) link/connection/interface, vehicle-to-everything (V2X) link/connection/interface, vehicle-to-infrastructure (V2I) link/connection/interface, vehicle-to-pedestrian (V2P) link/connection/interface, device-to-device (D2D) link/connection/interface, or simply as SL, for example. The wireless interfaces 190, 195 may utilize any suitable radio access technology. For example, the wireless system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless communications.

The RANs 120 are in communication with the core network 130 to provide the UEs 110 with various services such as voice, data, and other services. The RANs 120 and/or the core network 130 may be in direct or indirect communication with one or more other RANs (not shown), which may or may not be directly served by core network 130, and may or may not employ the same radio access technology. The core network 130 may also serve as a gateway access between (i) the RANs 120 or UEs 110 or both, and (ii) other networks (such as the PSTN 140, the internet 150, and the other networks 160). In addition, some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or switch (not shown), and to the internet 150. PSTN 140 may include circuit switched telephone networks for providing plain old telephone service (POTS). The internet 150 may include a network of computers and subnets (intranets) or both, and incorporate protocols, such as Internet Protocol (IP), Transmission Control Protocol (TCP), User Datagram Protocol (UDP). The UEs 110 may be multimode devices capable of operation according to multiple radio access technologies, and incorporate multiple transceivers necessary to support such.

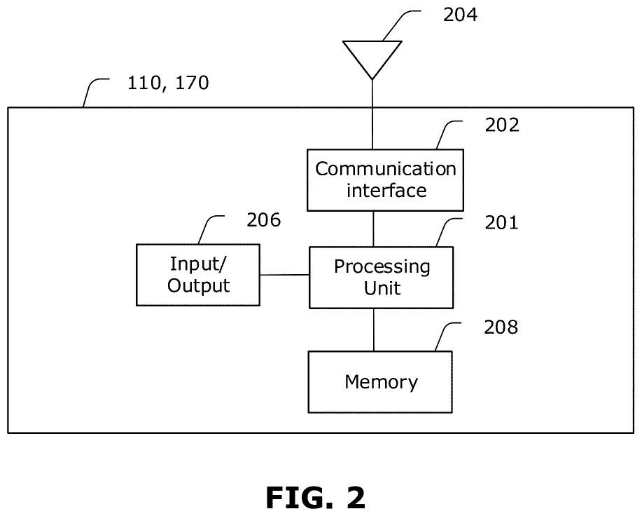

FIG. 2 illustrates an example apparatus that may implement the methods and teachings according to this disclosure. FIG. 2 illustrates a possible embodiment for the UE 110 and BS 170, and is not intended to be limiting.

As shown in FIG. 2, an example apparatus (e.g., an example embodiment of the UE 110 or BS 170) includes at least one processing unit 201. The processing unit 201 implements various processing operations of the apparatus. For example, the processing unit 201 could perform signal coding, data processing, power control, input/output processing, or any other functionality of the apparatus. The processing unit 201 may also be configured to implement some or all of the functionality and/or embodiments described in more detail herein. Each processing unit 201 includes any suitable processing or computing device configured to perform one or more operations. Each processing unit 201 could, for example, include a microprocessor, microcontroller, digital signal processor, field programmable gate array, or application specific integrated circuit.

The apparatus (e.g., the UE 110 or BS 170) includes at least one communication interface 202 for wired and/or wireless communications. One or multiple communication interfaces 202 could be used in the apparatus. Each communication interface 202 includes any suitable structure for generating signals for wireless or wired transmission and/or processing signals received wirelessly or by wire. Although shown as a single functional unit, the communication interface 202 could also be implemented using at least one transmitter interface and at least one separate receiver interface. In some examples, one or more transmitters and one or more receivers may be implemented by the communication interface 202.

The apparatus in this example includes at least one antenna 204 (in other examples, the antenna 204 may be omitted). Each antenna 204 includes any suitable structure for transmitting and/or receiving wireless or wired signals. One or multiple antennas 204 could be used in the apparatus. In some examples, one or more antennas 204 may be an antenna array 204, which may be used to perform beamforming and beam steering operations. In some examples, there may be one or more antennas 204 used for transmitting signals and separate one or more antennas 204 used for receiving signals.

The apparatus (e.g., the UE 110 or BS 170) further includes one or more input/output devices 206 or input/output interfaces (such as a wired interface to the internet 150). The input/output device(s) 206 permit interaction with a user or other devices in the wireless system 100. Each input/output device 206 includes any suitable structure for providing information to or receiving information from a user, such as a speaker, microphone, keypad, keyboard, display, or touchscreen, including network interface communications.

In addition, the apparatus (e.g., the UE 110 or BS 170) includes at least one memory 208. The memory 208 stores instructions and data used, generated, or collected by the apparatus. For example, the memory 208 could store software instructions or modules configured to implement some or all of the functionality and/or embodiments described herein and that are executed by the processing unit(s) 201. Each memory 208 includes any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

Techniques for generating cross-packet check blocks (also referred to as vertical check blocks (VCBs) or cross-code block (CB) check blocks), have been described in U.S. patent application Ser. No. 16/665,121, entitled “SYSTEM AND METHOD FOR HYBRID-ARQ”, filed Oct. 28, 2019, the entirety of which is hereby incorporated by reference. The use of cross-packet check blocks in network coding (also referred to as 2D network coding or 2D joint network coding) has been described in U.S. patent application Ser. No. 17/110,226, entitled “METHODS AND SYSTEMS FOR NETWORK CODING USING CROSS-PACKET CHECK BLOCKS”, filed Dec. 2, 2020, the entirety of which is hereby incorporated by reference.

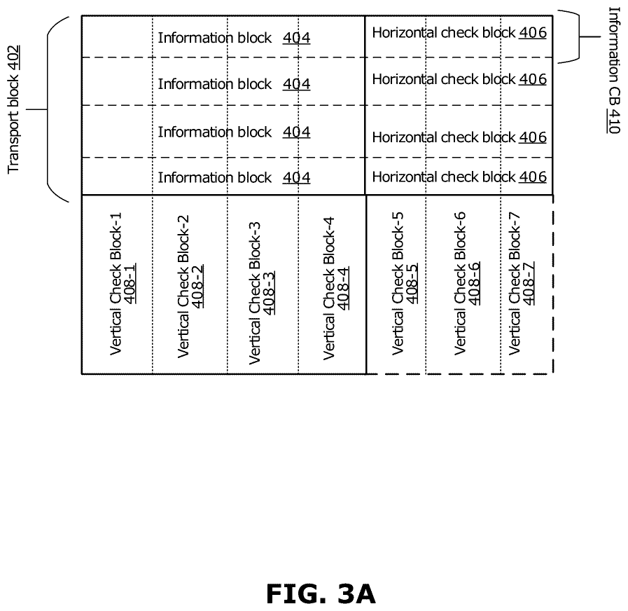

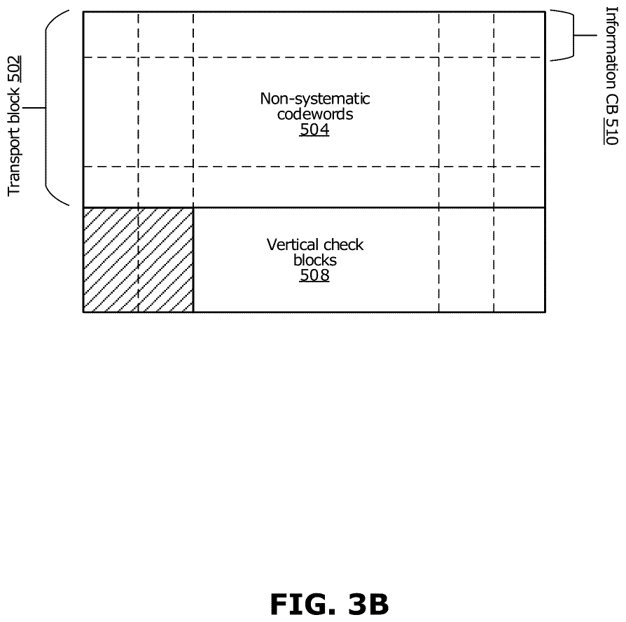

FIG. 3A illustrates an example code structure for a single TB 402. The TB 402 includes multiple information blocks 404 formed from encoder input bits (in this example, four information blocks 404 are shown for simplicity, however this is not intended to be limiting). The encoder input bits may also be referred to as information bits. The bits in this example are arranged in L rows and K columns. The code structure includes check blocks that are each generated using bits from a single information block 404; such check blocks are may be referred to as horizontal check blocks 406 (in this example, one horizontal check block 406 for each information block 404). The code structure also includes check blocks that are generated using bits selected from across two or more information blocks 404; such check blocks may be referred to as vertical check blocks 408. However, it should be understood that the terms “vertical” and “horizontal” are not intended to imply any physical structure or orientation and are not intended to be limiting; for example, the descriptors “horizontal” and “vertical” may be equally replaced with “first” and “second”, respectively. As will be discussed further below, vertical check blocks 408, when used in examples applicable to network coding, may be referred to as cross-packet check blocks. It should be understood that the terms “parity block” or “redundancy block” may also be used instead of “check block”.

In this example, vertical check blocks 1-7 408-1 to 408-7 (generally referred to as vertical check block(s) 408) are shown, however this is not intended to be limiting. In particular, vertical check blocks 5-7 408-5 to 408-7 are shown using dashed lines to indicate that vertical check blocks 5-7 408-5 to 408-7, which are generated using bits selected from across two or more horizontal check blocks 406, are optional. Vertical check blocks 5-7 408-5 to 408-7 may be referred to as “check on check” blocks.

The number of vertical check blocks 408 to be used (including whether check on check blocks are used) may be based on configuration at the transmitting node (e.g., the BS 170 for downlink DL transmissions, or the UE 110 for uplink UL transmissions or SL transmissions) and/or defined by a standard.

Each row in the code contains n₁ bits, including k₁ encoder input bits (or information bits) (in one information block 404) and a respective horizontal check block 406 containing n₁-k₁ check bits. Each information block 404 and corresponding horizontal check block 406 may be viewed as an n₁ bit information CB 410, with the TB 402 having multiple information CBs 410. In the example of FIG. 3A, the information CBs 410 are systematic CBs in that they each include systematic bits (in the information block 404) and check bits (in the horizontal check block 406) determined from the systematic bits. In other examples (discussed further below), the information CBs 410 may be non-systematic.

Each vertical check block 408 is generated from k₂ encoder input bits (or information bits) selected across multiple information blocks 404. The k₂ selected bits include M encoder input bits from each of the L information CBS 410, where M≥1, such that k₂=MxL. In other words, the k₂ cross-block bits include the bits from one of the K columns, and each column is M bits wide. In some examples, k₂ cross-block bits may include different numbers of information bits taken from each information CB 410. This may be expressed mathematically as: k₂=M₁+ . . . +M_{L}, where Mᵢ is the number of information bits taken from each of the L information CBs 410, Mᵢ>0 and there is no requirement for Mₚ=M_{q}, when p≠q. The combination of the selected k₂ cross-block bits may be considered a vertical information block (where the term “vertical” is to distinguish from the “horizontal” information blocks 404), which is then encoded (e.g., using a forward error correction (FEC) code, such as low-density parity-check (LDPC) code) to obtain the vertical check block 408.

FIG. 3A shows, and has been described with, bits being arranged in rows and columns; for example, the vertical check block 408 is shown as having a rectangular or two-dimensional structure. However, this is only for the purpose of illustration and is not intended to limit how the bits are arranged logically or in transmission. Further, the code structure shown in FIG. 3A may be divided up for transmission. Typically, all the bits of one vertical check block 408 are transmitted in the same transmission.

The check bits contained in the horizontal check blocks 406 and vertical check blocks 408 are useful to assist decoding at a receiving node. For example, after each decoding attempt at a decoder, where check bits are present, error checking can be performed to determine if the information bits in the information CB 410 have been successfully decoded. The vertical check block 408 contains check bits determined from across multiple information CBs 410, and thus provides information useful for decoding multiple information CBs 410. The decoder may use the check bits of the vertical check block 408 to assist in decoding of an information CB 410.

FIG. 3B illustrates an example code structure for a single TB 502 based on a non-systematic code (e.g., Polar code, block code, or convolutional code). Each non-systematic codeword is determined based on a set of encoder input bits, but the information bits do not appear in the codeword as systematic bits. Unlike systematic codes, horizontal check bits cannot be simply appended at the end of each row.

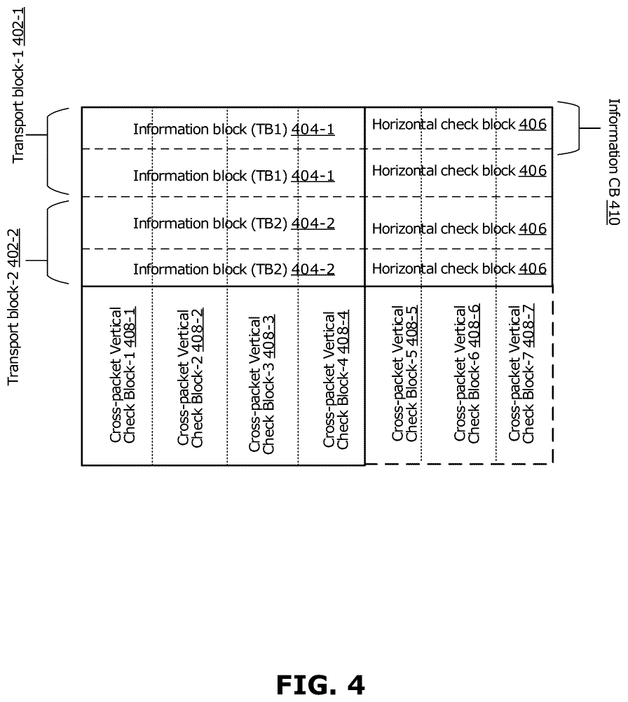

The TB 502 includes multiple non-systematic codewords 504. Each non-systematic codeword 504 may be viewed as an information CB 510. Unlike the example of FIG. 3A, the information CB 510 does not include a distinct horizontal check block. Each vertical check block 508 is generated by one or more columns of bits taken across multiple information CBs 510, similar to that described for FIG. 4.

It will be appreciated by persons skilled in the art that present disclosure is not dependent on whether systematic or non-systematic code is used. For simplicity, the following discussion may make reference to and use reference numbers referencing the example of FIG. 3A based on systematic CBs. It should be understood that this is not intended to be limiting.

As mentioned above, each vertical check block 408 is generated from bits selected from across multiple information CBs 410. In particular, if the information CBs 410 are arranged in horizontal rows in the code structure (e.g., as illustrated in FIGS. 3A, 3B and 4), the vertical check blocks 408 may be generated by selecting vertical columns of bits, where each column of bits contains bits from across the multiple rows of information CBs 410. A set of vertical check blocks 408 may thus be generated, where each vertical check block 408 is generated using a respective vertical column of bits (as illustrated by the use of dotted lines in FIGS. 3A, 3B and 4). The order of bits in each information CB 410, as outputted by the encoder, may be referred to as the “natural order” of the bits. Additional sets of vertical check blocks 408 may be generated by shuffling (or interleaving) the bits within each information CB 410 (such the vertical columns of bits that are obtained after the shuffling or interleaving is different from the vertical columns of bits that are obtained when the bits of the information CBs 410 are in their natural order). A predefined shuffling scheme or predefined interleaver may be used to perform this shuffling or interleaving. An interleaver may be a predefined algorithm or predefined matrix (among other possibilities) that is applied to the row of bits to obtain a reordered row of bits. It should be understood that other techniques (not necessarily limited to interleaving) may be used.

Regardless of whether the TB is based on a systematic or non-systematic code, in transmission, the information CBs (transmitted with the corresponding horizontal check blocks in the case of a systematic code) may be transmitted in an initial transmission. Vertical check blocks may be transmitted together with the information CBs in the initial transmission, or in a separate transmission (which may be referred to as a retransmission). Although retransmission can include just the bits from vertical check block(s), retransmission can also include some information bits related to the vertical check block(s) in the retransmission.

In examples where the information CBs are systematic (such as low density parity check (LDPC) code or Turbo code), an iterative decoding process may be used at the decoder (at the receiving node) to decode the received CBS. The decoder calculates log-likelihood ratios (LLRs) of bit values during decoding of the information CBs, which may be considered a “soft” output of the decoder. In the present disclosure, soft output may refer to decoder output that is not yet finalized (e.g., bit value not yet definitively determined to be 1 or 0 value) but may provide information that can still be useful (e.g., in a subsequent decoding iteration). Such soft output may be probabilistic in nature (e.g., LLR). Information CBs that are not correctly decoded (e.g., fails a check using the corresponding horizontal check blocks) may benefit from processing the vertical check blocks. Because each of the vertical check blocks is generated from information bits selected from two or more (or all) of the information CBS, soft output from attempts to decode a vertical check block 408 (e.g., LLR) may help to improve decoding of the information CBs (and vice versa). In at least this way, vertical check blocks help to improve decoding.

The present disclosure is not limited to a systematic code, and may be equally applicable and implemented with a non-systematic code. Further, although the present disclosure describes examples that use vertical check blocks in the context of unicast transmission/retransmissions (i.e., between one transmitting node and one receiving node), it should be understood that the examples described herein may also be suitable for multicast, groupcast and broadcast transmissions/retransmissions, among others.

The preceding discussion describes vertical check blocks 408 generated from bits selected from two or more CBs 410 in a single TB 402. Vertical check blocks 408 may also be generated from bits selected over two or more TBs, which may correspond to two or more packets, in a network coding application. To assist in understanding this further application, a discussion of network coding is provided.

Network coding is a networking technique in which transmitted data is encoded and decoded to help increase network throughput, help reduce delays and/or help improve robustness of the wireless network. Instead of treating two packets as distinct, discrete units of information (as in traditional network routing), network coding enables the two packets to be merged (using a certain defined algebraic algorithm, which may be defined by standards) and the accumulated message delivered to a destination node. At the destination node, the accumulated message is decoded (using the same defined algorithm). The two packets that are merged in this way may be from two different source nodes, or two different transmitting devices (e.g., two different antennas, two different transmitters, or two different communication interfaces) of the same source node or different source nodes. In the present disclosure, a source node refers to the node in the wireless communication system that originally generated the transmitted packet (i.e., is not a relay node, which forwards a packet that it did not itself generate). For example, a BS 170 may be a source node for DL transmissions, and a UE 110 may be a source node for UL transmissions. The two packets may be intended for the same destination node, or two different destination nodes (e.g., two different receiving devices). In the present disclosure, a destination node refers to the node in the wireless communication system that is the final destination of the transmitted packet (i.e., is not a relay node). For example, a UE 110 may be a destination node for DL transmissions, and a BS 170 may be a destination node for UL transmissions. In the case where the two packets are intended for two different destination nodes, additional information may be used at each destination node in order to decode and obtain only the packet intended for that destination node.

When vertical check blocks are used with network coding, a given vertical check block may be generated from bits taken across two or more packets (which may come from single TB or multiple TBs). Accordingly, in network coding applications, vertical check blocks may also be referred to as cross-packet vertical check blocks (or simply cross-packet check blocks). The present disclosure will generally refer to cross-packet vertical check blocks (i.e., check blocks generated using bits selected from across two or more packets), when discussing network coding applications. In some examples, the use of cross-packet vertical check blocks in network coding may also be referred to as two-dimensional (2D) joint coding, where 2D refers to the generation of cross-packet check blocks in addition to horizontal check blocks (in the case of systematic code), and joint coding refers to how information from the two or more packets are jointly encoded in the cross-packet check blocks.

FIG. 4 illustrates an example code structure similar to that of FIG. 3A. However, unlike FIG. 3A, the structure in FIG. 4 includes multiple TBs, in this example TB-1 402-1 and TB-2 402-2 (generally referred to as TB(s) 402). The multiple TBs 402 may originate from one or more source nodes (and the number of source nodes may or may not be the same as the number of TBs 402). Multiple TBs 402 may correspond to different packets generated by the same source node or different source nodes. In this example, two TBs 402 are shown for simplicity, however this is not intended to be limiting. TB-1 402-1 has encoder input bits arranged in rows forming information blocks 404-1 (in this example, two information blocks 404-1 are shown for simplicity, however this is not intended to be limiting), and TB-2 402-2 has encoder input bits arrange in rows forming information blocks 404-2 (in this example, two information blocks 404-2 are shown for simplicity, however this is not intended to be limiting). The information blocks 404-1, 404-2 may be generally referred to as information block(s) 404. It should be noted that the number of information blocks 404 in each TB 402 is not necessarily equal. In this example, systematic code is shown, and a horizontal check block 406 is generated from each information block 404. In examples using non-systematic code, there may not be any horizontal check block 406 distinct from the information block 404.

In this example, two different packets may be encoded in the two TBs 402, where each packet is intended for a respective different destination node. Accordingly, vertical check blocks 1-7 408-1 to 408-7 are referred to as cross-packet vertical check blocks 1-7 408-1 to 408-7 (generally referred to as cross-packet vertical check block(s) 408), using the same reference numeral. As previously described, the number of cross-packet vertical check blocks 408 to be used (and whether check on check blocks are used) may be based on configuration at the source node (e.g., the BS 170 for DL transmissions, or the UE 110 for UL transmissions) and/or defined by a standard.

To generate each cross-packet vertical check block 408, one or more bits are selected from each TB 402 (e.g., one or more bits selected from TB-1 402-1 and one or more bits selected from TB-2 402-2). The selected bits may be referred to as cross-TB (or cross-packet) bits. The cross-packet bits that are selected to generate a given cross-packet vertical check block 408 may be referred to as a vertical information block or cross-packet information block, for example. The vertical information block is encoded (e.g., using FEC code, such as LDPC code) to obtain the corresponding cross-packet vertical check block 408. The cross-packet vertical check blocks 408 that are generated across multiple TBs 402 may be generated based on the encoder input bits in their natural order, or based on interleaved encoder input bits. Multiple sets of cross-packet vertical check blocks 408 may be thus generated for the same set of TBs 402, using different interleavers (e.g., using a different interleaver for each different redundancy version (RV) index). The cross-packet vertical check blocks 408 may be generated for a systematic or non-systematic code.

Although the present disclosure uses the term “vertical”, it should be understood that this is not intended to be limiting. Further, cross-packet vertical check blocks may be simply referred to as cross-packet check blocks. It should be noted that although the term “check block” may be used to refer to parity bits, this is not intended to be limiting. In some examples, a retransmission that transmits a cross-packet vertical check block may also include information bits along with the parity bits.

The use of cross-packet vertical check blocks in network coding retransmission schemes provides advantages (e.g., increased efficiency, reduced latency, etc.) particularly for retransmission of packets intended for multiple destination nodes. For example, because a single cross-packet vertical check block can provide information to help in decoding of multiple different packets (with different intended destination nodes), fewer resources (e.g., network resources used for the retransmission itself, as well as resources used for control signaling related to the retransmission) need to be used for the retransmission. In some examples, there may be additional diversity gain because the decoder at a given destination node may be able to combine information received from the initial transmission of all packets as well as information from the retransmission. Since different individual packets may have been transmitted via different independent communication channels (particularly in the case where the packets originate from different source nodes), the diversity gain may be expected to be greater when using cross-packet vertical check blocks in network coding. Additionally, latency may be reduced because fewer retransmissions may be needed.

However, the use of cross-packet vertical check blocks in network coding raises an important consideration related to data privacy when the cross-packet vertical check blocks are generated using packets intended for different destination nodes. The challenge arises due to the conventional use of UE-specific scrambling sequences to ensure data privacy.

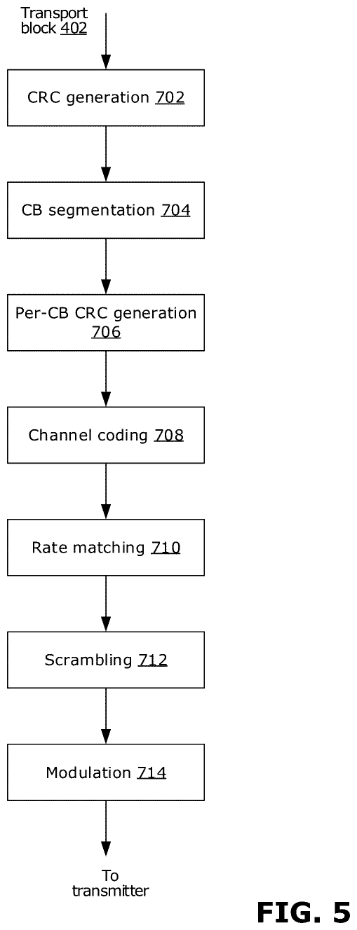

FIG. 5 is an example dataflow illustrating how a UE-specific identifier (e.g., cell radio network temporary identifier (C-RNTI)) is conventionally used in data transmission for scrambling.

Starting with a TB 402, CRC generation 702 generates a cyclic redundancy check (CRC) block that is appended to the TB 402. Then, at CB segmentation 704, the TB 402 (with CRC appended) is segmented into one or more CBs (note that the appended CRC is included in the segmentation). Per-CB CRC generation 706 is performed to generate a CRC block for each CB (i.e., the horizontal check block 406 for each information CB 410). Then, channel coding (e.g., using low-density parity-check (LDPC) code) 708 is performed for each CB, followed by rate matching 710 (and optionally other processes such as interleaving). The output of the rate matching 710 is a sequence of coded bits, which is processed by scrambling 712. Scrambling 712 may involve performing a bitwise XOR operation between the sequence of coded bits and a scrambling sequence. In particular, the scrambling 712 is typically performed using a pseudo-random sequence which is typically generated based on a UE-specific identifier (e.g., the C-RNTI of the UE that is the intended destination of the TB 402). Finally, modulation 714 is performed. The modulated symbols may be further processed (e.g., layer mapping, precoding, resource mapping, etc.) and the resulting signal may be transmitted by a transmitter.

It should be noted that not only is the TB 402 scrambled using the UE-specific identifier (e.g., using a pseudo-random sequence that is a function of the UE-specific identifier), but its related control channel information may also be scrambled using the UE-specific identifier of the intended recipient UE. For example, transmission of the TB may be scheduled by a downlink control information (DCI) transmission in the physical downlink control channel (PDCCH). A CRC block is typically appended to the DCI payload, and the CRC block is typically also scrambled using the UE-specific identifier (e.g. C-RNTI).

The above-described use of a UE-specific identifier for scrambling may not be suitable in 2D HARQ for network coding. Consider, for example, the scenario where a BS 170 (i.e., a source node) is scheduling a retransmission for two different UEs 110 (i.e., two different destination nodes), referred to as UE1 and UE2, using cross-packet vertical check blocks. Using conventional, UE-specific, scheduling methods, the data and control channel information for the initial transmission are scrambled by the BS 170 using a UE-specific identifier, depending on which UE is the intended destination node. That is, the control channel information and data intended for UE1 are scrambled using a scrambling sequence that is based on the UE-specific identifier specific to UE1 (e.g., the scrambling sequence may be the C-RNTI specific to UE1, or may be a function of the C-RNTI specific to UE1) and the control channel information and data intended for UE2 is scrambled using a scrambling sequence that is based on the UE-specific identifier specific to UE2 (e.g., the scrambling sequence may be the C-RNTI specific to UE2, or may be a function of the C-RNTI specific to UE2). Then, UE1 and UE2 may use their own respective C-RNTI (which is not known to each other) to decode their own data and control channel information. However, when using cross-packet vertical check blocks in network coding, the retransmission includes data intended for both UE1 and UE2 (because the cross-packet vertical check blocks are generated using bits selected from both packet(s) intended for UE1 and packet(s) intended for UE2). In this scenario, scrambling the retransmission using the UE-specific identifier of UE1 would mean that UE1 would have access to data intended for UE2 (leading to a loss of data privacy) and further UE2 would not be able to decode the retransmission (so that UE2 does not benefit from the retransmission), and vice versa. The present disclosure describes examples that provide a solution to this problem.

In various examples, the present disclosure describes the use of a network coding identifier for scrambling, which may be used to address at least some of the challenges described above. In some examples, the network coding identifier may be generated and used in a manner similar to existing C-RNTI (e.g., in existing LTE wireless systems). As such, the network coding identifier disclosed herein may be referred to as a network coding RNTI (NC-RNTI) however this is not intended to limit the present disclosure to any particular wireless technology.

The network coding identifier may be known to all UEs participating in a given network coding transmission (e.g., an initial transmission or a retransmission using network coding). For example, the network coding identifier may be known to all UEs that have been configured for a given network coding group, or all UEs that have been configured to participate in a given network coding transmission. For example, the network coding identifier may be used as a scrambling sequence or may be used to generate a scrambling sequence (e.g., the scrambling sequence may be a pseudo-random function of the network coding identifier) for transmissions and retransmissions in the network coding group.

The network coding identifier may be used to scramble information that should be decodable by all UEs in the network coding group, such as control channel information related to a retransmission; however, the network coding identifier does not enable any UE to decode the data contained in a TB. The data contained in the TB itself may be scrambled using the UE-specific identifier specific to the UE that is the intended recipient of the TB, such that only the intended recipient UE is able to decode the TB, thus ensuring data privacy. In the present disclosure, scrambling using the network coding identifier may refer to scrambling using the network coding identifier itself as the scrambling sequence, as well as scrambling using a scrambling sequence that is a function of the network coding identifier. Further, different instances of scrambling using the network coding identifier may be performed using different scrambling sequences even though the network coding identifier remains the same. For example, the CRC of a DCI may be scrambled using the network coding identifier, where the network coding identifier itself is used as the scrambling sequence; and an initial transmission be scrambled using the network coding identifier, where the scrambling sequence is a function of the network coding identifier. Similarly, scrambling using the UE-specific identifier may refer to scrambling using the UE-specific identifier itself as the scrambling sequence, as well as scrambling using a scrambling sequence that is a function of the UE-specific identifier. Further, different instances of scrambling using the UE-specific identifier may be performed using different scrambling sequences even though the UE-specific identifier remains the same.

A network coding group may be configured semi-statically or dynamically, as discussed further below. UEs that belong to a configured network coding group may participate in network coding transmissions within the group, including retransmissions that use cross-packet vertical check blocks. Further, retransmissions may be dynamically configured within a network coding group, such that not all UEs configured for the network coding group necessarily participate in each retransmission within the network coding group. Use of the network coding identifier for scrambling transmissions may prevent any UE that has not been configured for the network coding group from decoding the transmissions of the network coding group.

A UE-specific identifier may be used to scramble UE-specific data (e.g., data contained in a TB that is intended for a specific UE), to ensure data privacy, before generating the cross-packet vertical check blocks for a retransmission. Then, the network coding identifier may be used to scramble the retransmission. In this way, all UEs belonging to the network coding group is able to decode and make use of the cross-packet vertical check blocks to assist in decoding, but at the same time no UE is able to access data that is intended for another UE. The use of the network coding identifier for scrambling in addition to use of the UE-specific identifier for scrambling may be referred to as two-level scrambling, in some examples.

It should be understood that, although the present disclosure includes examples in the context of HARQ retransmission schemes (i.e., retransmissions using cross-packet vertical check blocks; also referred to as 2D HARQ), this is not intended to be limiting. Examples of the present disclosure, may be applicable to other network coding schemes. For example, the network coding identifier may be used in various applications with or without HARQ retransmission. For example, a network coding scheme may instead combine information bits from different packets (intended for different destination nodes) using XOR or using a linear combination (among other possibilities) to generate a network coded information packet for retransmission. The network coded information packets may be further encoded by a PHY layer FEC code (such as LDPC codes) for retransmission. In another example, an outer code may be applied to the information bits of the different packets in the initial transmissions to generate new outer coded parity information blocks. An example of outer code can be a simple XOR of information bits, raptor codes, Reed-Solomon (RS) codes etc. Some examples of outer codes are described in U.S. Pat. No. 10,505,568, “SYSTEMS AND METHODS FOR OUTER CODING”, and in U.S. Pat. No. 11,146,363, “SYSTEMS AND METHODS FOR HARQ RETRANSMISSION USING AN OUTER CODE”, the entireties of which are all hereby incorporated by reference. These outer coded parity information blocks may be further encoded by a PHY layer FEC code (such as LDPC codes) to produce the cross-packet coded bits for retransmission. This may be referred to as cross-packet coding (because the coding is performed using information bits from different packets) or cross-UE coding (because the coding is performed using information bits from packets intended for different UEs), for example. The cross-packet vertical check blocks described previously may be considered an example of cross-packet coding. Regardless of how the retransmission is generated, the two-level scrambling disclosed herein may be beneficial. By using the respective UE-specific identifier to scramble respective information bits intended for a respective destination node, generating the coded bits for the retransmission using some combination of the scrambled information bits, and then using the network coding identifier to further scramble the coded bits for the retransmission, data privacy may be preserved for each destination node while enabling each destination node to make use of the retransmission to aid in decoding.

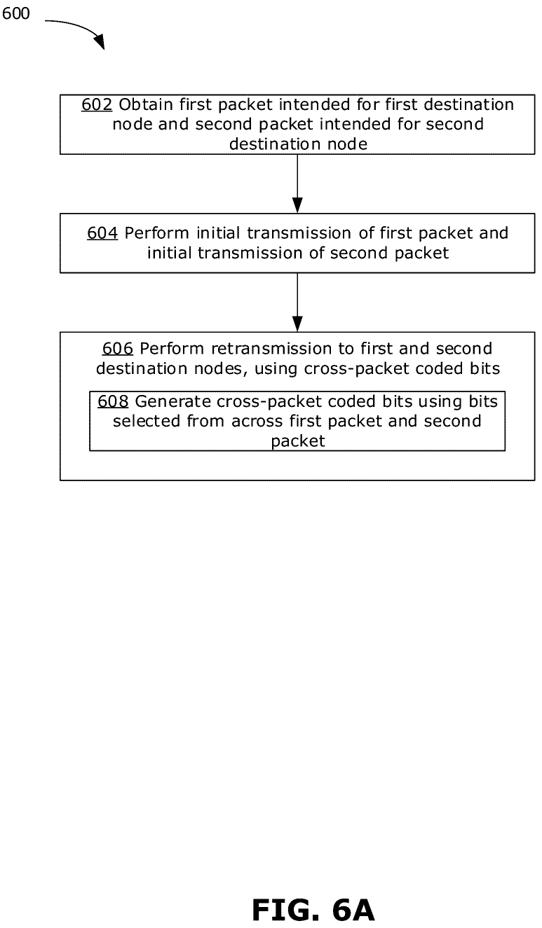

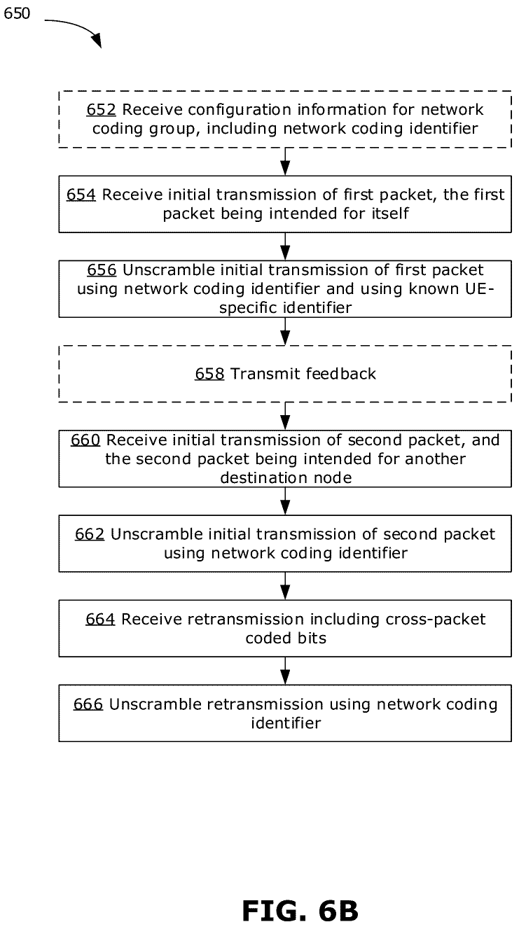

FIG. 6A is a flowchart illustrating an example method 600, which may be performed at a source node (e.g., a network node, such as the BS 170), for performing an initial transmission and a retransmission. In particular, the method 600 includes the use of cross-packet coding for the retransmission.

It should be noted that the following discussion assumes that any necessary configuration information (e.g., configuration information for configuring the first and second destination nodes for the same network coding group) is communicated using any suitable signaling (e.g., semi-static signaling or dynamic signaling), and is not discussed in detail. Examples of how configuration information may be communicated, including communication of the network coding identifier for the network coding group, are provided further below.

At 602, a first packet intended for a first destination node (e.g., a first UE 110) and a second packet intended for a second destination node (e.g., a second UE 110) are obtained. For example, the first and second packets may be obtained internally (e.g., generated internally by the source node).

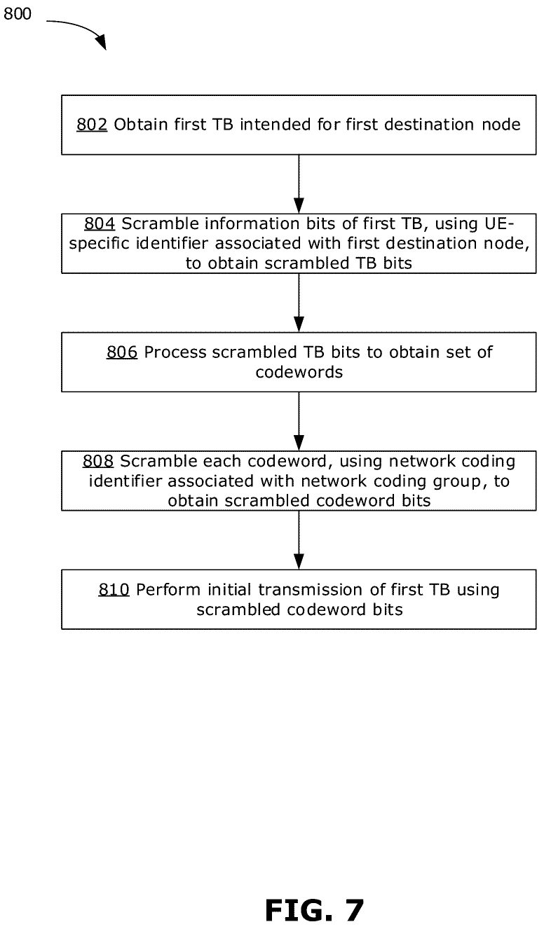

At 604, an initial transmission of the first packet and an initial transmission of the second packet are performed. The initial transmission of the first packet is transmitted to both the first and second destination nodes; the initial transmission of the second packet is transmitted to both the first and second destination nodes. As will be discussed further below with respect to FIG. 7, each initial transmission may be scrambled using the respective UE-specific identifier. In some examples, the initial transmission may also be scrambled using the network coding identifier (e.g., if two-level scrambling is used).

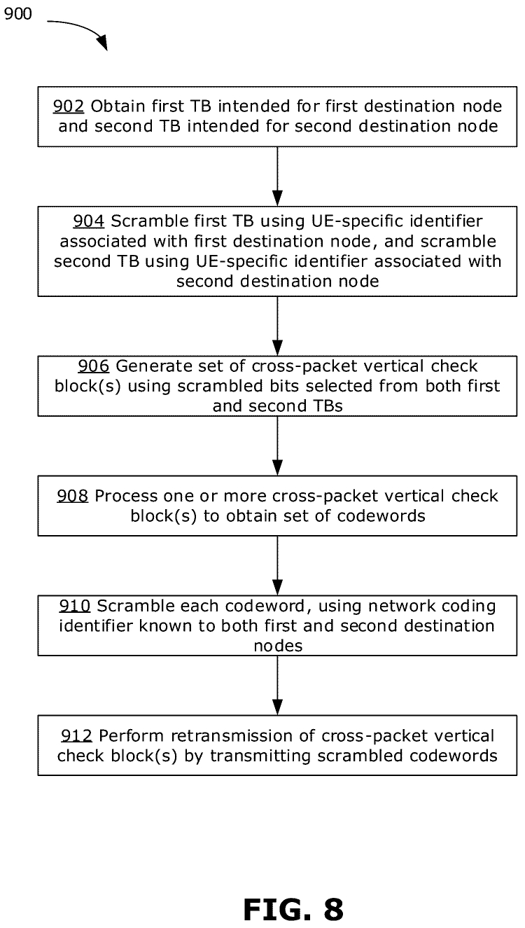

At 606, a retransmission is performed to the first and second destination nodes, using cross-packet coded bits. Prior to performing the retransmission, the source node may make a determination that a retransmission is required (not shown in FIG. 6). For example, the determination that a retransmission is required may be based on a negative response from the first and/or second destination node indicating that the respective first and/or second packet was not successfully decoded; in another example, the determination that a retransmission is required may be based on whether a predefined number of retransmissions has been performed. As will be discussed further below with respect to FIG. 8, performing the retransmission may include scrambling the cross-packet coded bits using an identifier that is known to both the first and second destination nodes. In particular, the first and second destination nodes may be configured for network coding in the same network coding group, and the cross-packet coded bits may be scrambled using the network coding identifier of the network coding group. In some examples, the information bits, which are used to generate the cross-packet coded bits, may be first scrambled using UE-specific identifiers, to maintain data privacy, as discussed further below.

Performing the retransmission includes generating the cross-packet coded bits at step 608.

At 608, the cross-packet coded bits are generated using information bits selected from across the first packet and the second packet. The cross-packet coded bits may be a set of one or more cross-packet vertical check blocks, as described previously. The cross-packet coded bits may also be generated using any other suitable cross-packet coding scheme such as combining the information bits of the first and second packets using XOR or a linear combination thereof.

FIG. 6B is a flowchart illustrating an example method 650, which may be performed at a destination node (e.g., a UE 110), for receiving and processing initial transmissions and retransmission. In particular, the method 650 includes the use of a network coding identifier and a UE-specific identifier for two-level descrambling. For simplicity, the method 650 will be described from the point of view of a first UE 110, which is the intended recipient of a first packet, as the destination node; however, it should be understood that the method 650 is applicable to any UE 110 participating in a network coding group.

Optionally, at 652, configuration information (e.g., configuration information for configuring the first destination node for the network coding group) is received via any suitable signaling (e.g., semi-static signaling or dynamic signaling), the details of which are discussed further below. In particular, the configuration information may include the network coding identifier for the network coding group.

At 654, an initial transmission of the first packet is received from a source node (e.g., BS 170). The intended recipient of the first packet is the first destination node itself. As will be discussed further below with respect to FIG. 7, the initial transmission may be scrambled using the UE-specific identifier associated with the first destination node. In some examples, the initial transmission may also be scrambled using the network coding identifier (e.g., if two-level scrambling is used).

At 656, the first destination node unscrambles the initial transmission of the first packet using the network coding identifier to recover the codewords, and attempts to decode the CRC block. The first destination node may also attempt to unscramble the information bits using its own (known to itself) UE-specific identifier, to recover the information bits of the first packet (which is intended for itself).

Optionally, at 658, the first destination node may transmit feedback to the source node, such as a NACK to indicate that decoding was unsuccessful. In some examples, feedback may only be transmitted if decoding was successful; or no feedback may be transmitted regardless.

At 660, an initial transmission of the second packet is received from the source node. It should be noted that while the intended recipient of the first packet is the first destination node itself, the intended recipient of the second packet is a different second destination node (e.g., second UE 110) that is in the same network coding group. Similarly to the initial transmission received at 654, the information bits of the initial transmission received at 660 may be scrambled using the UE-specific identifier associated with the second destination node (which is not known to the first destination node). In some examples, the network coding identifier may also be used to scramble the initial transmission of the second packet (e.g., if two-level scrambling is used).

At 662, the first destination node unscrambles the initial transmission of the second packet using the network coding identifier to recover the codewords, and attempts to decode the CRC block. The first destination node may not be able to unscramble the information bits of the second packet because the information bits are scrambled using the UE-specific identifier associated with the second destination node (which is not known to the first destination node). However, since the source node scrambled the information bits of the second packet using the UE-specific identifier before channel coding, the first destination node does not need to know the UE-specific identifier associated with the second destination node in order to decode the codeword(s).

At 664, a retransmission is received from the source node, including cross-packet coded bits (which may be cross-packet vertical check blocks, or may be generated by the source node using any suitable cross-packet coding scheme, as described above).

At 666, the first destination node unscrambles the retransmission using the network coding identifier. The first destination node attempts to decode the CRC block from the retransmission, and makes use of the cross-packet coded bits to assist in recovering the information bits of the first packet. At the same time, the first destination node is not able to use the information in the cross-packet coded bits to recover the information bits of the second packet because the information bits of the second packet were scrambled using the UE-specific identifier associated with the second destination node (which is not known to the first destination node).

Regardless of how the cross-packed coded bits are generated (e.g., may or may not be vertical check blocks), in some examples two-level scrambling may be used for the retransmission. As will be discussed further below, generating the cross-packet coded bits may involve first scrambling the information bits of each packet using the respective UE-specific identifier, and then generating the cross-packet coded bits from the scrambled information bits. That is, the information bits of the first packet may be first scrambled using the UE-specific identifier associated with the first destination node (e.g., using a scrambling sequence that is a function of the UE-specific identifier associated with the first destination node), and the information bits of the second packet may be first scrambled using the UE-specific identifier associated with the second destination node (e.g., using a scrambling sequence that is a function of the UE-specific identifier associated with the second destination node). Then the scrambled information bits may be combined to generate the cross-packet coded bits. The cross-packet coded bits may then be processed into codewords and the network coding identifier may be used to scramble the codewords for the retransmission (e.g., using a scrambling sequence that is a function of the network coding identifier). Thus, performing the retransmission may involve performing two-level scrambling as disclosed herein.

In the case where the cross-packet coded bits are cross-packet vertical check block(s), the information bits of the first packet may be first scrambled using the UE-specific identifier associated with the first destination node, and the information bits of the second packet may be first scrambled using the UE-specific identifier associated with the second destination node. CRC may be appended to the information bits after scrambling the UE-specific identifier. Then bits may be selected from both sets of scrambled information bits (including CRC if used) to generate vertical information block(s), which may be encoded into the cross-packet vertical check block(s). The cross-packet vertical check block(s) may then be processed into codewords, which are then scrambled using the network coding identifier.

FIG. 7 is a flowchart illustrating an example method 800, which may be performed at a source node (e.g., a network node, such as the BS 170), for an initial transmission of a TB that is intended for a first destination node (e.g., a first UE 110) using network coding. In particular, the method 800 includes the use of a network coding identifier for scrambling together with a UE-specific identifier for scrambling. For example, the method 800 may be performed for initial transmission of the first packet and for initial transmission of the second packet at step 604 of FIG. 6.

It should be noted that the following discussion assumes that any necessary configuration information (e.g., configuration information for generating a set of cross-packet vertical check blocks, such as any interleaver used; configuration information enabling destination nodes to know the network identifier; etc.) is communicated using any suitable signaling, and is not discussed in detail. Examples of how configuration information may be communicated, including communication of the network coding identifier, are provided further below.

At 802, a first TB that is intended for a first destination node (e.g., a first UE 110) is obtained. For example, the first TB may be obtained internally (e.g., generated internally by the source node).

At 804, the information bits of the first TB are scrambled in a first scrambling. The first scrambling is performed using the UE-specific identifier that is associated with (and specific to) the first destination node. For example, the UE-specific identifier may be the C-RNTI of the first UE 110 (where the first UE 110 is the first destination node). The UE-specific identifier may itself be used as the scrambling sequence for the first scrambling. In another example, the UE-specific identifier may be used to generate a pseudo-random scrambling sequence (e.g., the scrambling sequence may be a pseudo random sequence that is generated from an initialization seed as a function of the C-RNTI). The information bits of the first TB may be scrambled by performing an XOR operation with the bits of the scrambling sequence (which may be the UE-specific identifier itself, or may be a function of the UE-specific identifier), for example. The result is a set of scrambled TB bits. Notably, the scrambling using the UE-specific identifier is performed prior to CRC generation for the first TB.

At 806, the scrambled TB bits are processed to obtain a set of codewords. For example, CRC generation may be performed using the scrambled TB bits to generate a CRC block, and the CRC block is appended to the scrambled TB bits. This may be followed by CB segmentation, in which the scrambled TB bits with appended CRC block is segmented into one or more CBs (note that the appended CRC block is included in the segmentation). This may be followed by per-CB CRC generation to generate a CRC block for each CB. In the case where there is only one CB per TB, CB segmentation and per-CB CRC generation may be omitted. Channel coding and rate matching may be performed for each CB to generate a set of codewords. A set of codewords may be obtained by, for example, using a forward error correction (FEC) code, such as low-density parity-check (LDPC) code. Any suitable channel coding and rate matching process (and optionally other processes such as interleaving) may be used.

At 808, the bits of each codeword are scrambled in a second scrambling. This second scrambling is performed using the network coding identifier that is associated with (and specific to) the network coding group to which the first destination node belongs. As will be discussed further below, the first destination node (e.g., first UE 110) may be semi-statically or dynamically configured for the network coding group. The network coding identifier (e.g., NC-RNTI) is specific to the network coding group. The network coding identifier may itself be used as the scrambling sequence for the second scrambling. In another example, the network coding identifier may be used to generate a pseudo-random scrambling sequence (e.g., the scrambling sequence may be a pseudo random sequence that is generated from an initialization seed as a function of the NC-RNTI). The network coding identifier may be a bit sequence or an integer, which may be generated by the network (e.g., by the BS 170 itself, or another network node), that uniquely identifies the network coding group. In particular, the network coding identifier should not conflict with other identifying sequences (e.g., other C-RNTIs) currently in use. The bits of each codeword may be scrambled by performing an XOR operation with the bits of the scrambling sequence (which may be the network coding identifier itself, or may be a function of the network coding identifier), for example. The result is a set of scrambled codeword bits.

At 810, an initial transmission of the first TB may be performed using the scrambled codeword bits. For example, the scrambled codeword bits may be further processed (e.g., modulating, layer mapping, precoding, resource mapping, etc.) and the resulting signal may be transmitted by a transmitter of the source node. Notably, although the first TB contains data that is intended for the first destination node, the initial transmission may be to multiple destination nodes (including the intended first destination node) that are part of the network coding group for which the first destination node has been configured. Because the information bits of the first TB is scrambled using the UE-specific identifier associated with (and specific to) the first destination node, and the UE-specific identifier of the first destination node is not known by any other destination node in the network coding group, data privacy is preserved. At the same time, each destination node that receives the initial transmission is able to unscramble the codewords and attempt to decode the CRC block, because the UE-specific identifier is used to scramble only the information bits of the TB and not the CRC block. The network coding identifier, which is used for scrambling of the codewords (including the CRC block), is known to all destination nodes configured for the network coding group.

The method 800 may be performed by the source node for each initial transmission of a TB that is intended for any destination node configured (semi-statically or dynamically) in a network coding group. If a retransmission is required (e.g., if one or more retransmissions are scheduled with the initial transmission, or if a negative acknowledgement (NACK) is received from one or more destination nodes), the source node may perform retransmission using method 900 discussed further below.

Some details of the scrambling process using the network coding identifier are now described. In general, the networking coding identifier may be used to scramble the codeword bits using any existing scrambling processing (e.g., as described in standards, for example 3GPP TS 38.211).

For example, the scrambling process for the downlink shared channel (PDSCH) is described. For each codeword q that is generated (e.g., each codeword in the set of codewords generated at step 806), the block of coded bits may be represented as b^{(q)}(0), . . . , b^{(q)}(M_{bit}^{(q)}−1), where b^{(q)}(i) denotes the i-th bit of the codeword q, and M_{bit}^{(q)} denotes the total number of bits in the codeword q. The block of coded bits are scrambled prior to modulation, resulting in a block of scrambled codeword bits represented as \tilde{b}^{(q)}(0), . . . , \tilde{b}^{(q)}(M_{bit}−1), where \tilde{b}^{(q)}(i) denotes the i-th scrambled codeword bit. The scrambling may be performed according to the following equation:

$${\tilde{b}}^{( q )} ( i ) = ( {b}^{( q )} ( i ) + {c}^{( q )} ( i ) ) mod 2$$

where c^{(q)}(i) denotes the i-th bit of the scrambling sequence (which is based on the network coding identifier). The scrambling sequence may be a pseudo random sequence that is generated as a function of the network coding identifier. For example, pseudo random sequences may be defined based on a length-31 Gold sequence. For example, a sequence c(n) of length M_{PN}, where n=0,1, . . . , M_{PN}−1 may be defined as follows:

$$c ( n ) = ( {x}_{1} ( n + {N}_{c} ) + {x}_{2} ( n + {N}_{c} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

where N_{c}=1600 and the first m-sequence x₁(n) shall be initialized with x₁(0)=1,x₁(n)=0,n=1,2, . . . ,30. The initialization of the second m-sequence x₂(n) is denoted by cᵢₙᵢₜ=Σᵢ₌₀³⁰x₂(i)·2ⁱ with the value depending on the application of the sequence.

The scrambling sequence generator for this application may be initialized as follows:

$${c}_{init} = {n}_{RNTI} \cdot {2}^{15} + q \cdot {2}^{14} + {n}_{ID}$$

where q is the codeword index (e.g., if two codewords are transmitted, then q∈{0,1}; if a single codeword is transmitted, then q is equal to zero).

n_{ID} may be the cell ID of the network cell of the BS 170 or a specifically signaled ID. n_{RNTI} may be the C-RNTI (as used in the current NR standard, or may be the NC-RNTI as disclosed herein).

FIG. 8 is a flowchart illustrating an example method 900, which may be performed at a source node (e.g., a network node, such as the BS 170), for a retransmission to a network coding group. In particular, the retransmission may include one or more cross-packet vertical check blocks that are generated using bits selected from TBs that were originally intended for different destination nodes (e.g., different UEs 110). The method 900 includes the use of a network coding identifier for scrambling together with UE-specific identifiers for scrambling. For example, the method 900 may be performed for a retransmission to the first and second destination nodes, at step 606 of FIG. 6. It should be noted that although the method 900 describes the use of cross-packet vertical check block(s) for performing the retransmission, other techniques for cross-packet coding may be used instead to generate cross-packet coded bits for retransmission.

It should be noted that the following discussion assumes that any necessary configuration information (e.g., configuration information for generating a set of cross-packet vertical check block(s), such as any interleaver used; configuration information enabling destination nodes to know the network identifier; etc.) is communicated using any suitable signaling, and is not discussed in detail. Examples of how configuration information may be communicated, including communication of the network coding identifier, are provided further below.

At 902, a first TB that is intended for a first destination node (e.g., a first UE 110, denoted UE1) and a second TB that is intended for a second destination node (e.g., a second UE 110, denoted UE2) are obtained. The first and second TBs may have been previous transmitted in respective initial transmissions (e.g., using the method 800). In particular, the first and second destination nodes belong to the same network coding group (e.g., according to configuration information). As will be discussed further below, the first and second destination nodes may be configured semi-statically or dynamically to participate in the network coding group.

At 904, the information bits of the first TB are scrambled using the UE-specific identifier that is associated with (and specific to) the first destination node, and the information bits of the second TB are scrambled using the UE-specific identifier that is associated with (and specific to) the second destination node. For example, the UE-specific identifiers of the first and second destination nodes may be the respective C-RNTIs of UE1 and UE2, which may be used to generate respective pseudo-random scrambling sequences. The scrambling of the information bits may be performed as discussed above, for example. The scrambling of the information bits of the first and second TBs using respective UE-specific identifiers may be referred to as a first scrambling (or a first scrambling stage). The result is a set of scrambled TB bits for the first TB and a set of scrambled TB bits for the second TB. Following scrambling of the first and second TB using the respective UE-specific identifiers, CRC generation may be performed to generate and append a CRC block to each of the scrambled TB bits. That is, a CRC block is generated using the scrambled TB bits of the first TB and the CRC block is appended to the scrambled TB bits of the first TB; as well, another CRC block is generated using the scrambled TB bits of the second TB and the CRC block is appended to the scrambled TB bits of the second TB. An advantage of scrambling the information bits of the respective TBs using the respective UE-specific identifiers before generating and appending the CRC block (instead of scrambling the information bits of the respective TBs using the respective UE-specific identifiers after generating and appending the CRC block) is that the CRC block can be decoded (e.g., by all UEs 110 participating in the network coding) without knowing the UE-specific identifier that was used to scramble the information bits. This enables all UEs 110 in the network coding group to make use of the information encoded in the CRC block, without loss of data privacy.

At 906, a set of one or more cross-packet vertical check block(s) is generated (e.g., using parameters that may have been configured, such as a configured interleaver). For example, vertical information block(s) may be obtained by a selection of one or more scrambled information bits from the first TB and one or more scrambled information bits from the second TB. The CRC block generated from the scrambled information bits may also be used with the information bits for generating the vertical information block(s). Then cross-packet vertical check block(s) are generated by encoding the vertical information block(s) with a FEC code, such as LDPC code. Examples of how to generate cross-packet vertical information blocks from information bits from different packets are described in U.S. patent application Ser. No. 17/110,226, “METHODS AND SYSTEMS FOR NETWORK CODING USING CROSS-PACKET CHECK BLOCKS”, the entirety of which is hereby incorporated by reference.

As described earlier, in some other scenarios, in step 906, other network coding schemes may be used to generate cross-packet coded bits from the scrambled information bits from first and second packets. For example, a linear combination or a simple XOR of scrambled information bits from the first packet and scrambled information bits from the second packet may be used to generate network coded information packets. The network coded information packets may be further encoded using another physical layer FEC code (such as LDPC code) to produce cross-packet coded bits for retransmission. In another example, an erasure outer code, such as RS codes, or other outer codes (e.g., as described in previously-mentioned U.S. Pat. No. 10,505,568, “SYSTEMS AND METHODS FOR OUTER CODING”, and U.S. Pat. No. 11,146,363, “SYSTEMS AND METHODS FOR HARQ RETRANSMISSION USING AN OUTER CODE”) may be used to encode the scrambled information bits from the first packet and the scrambled information bits from the second packet to generate outer coded parity code blocks. These outer coded parity code blocks may be further encoded using another physical layer FEC code (such as LDPC code) to produce cross-packet coded bits for retransmission. It may be noted that the corresponding CRC blocks (that are generated from the respective scrambled information bits of the first packet and second packet) may be included with the scrambled information bits for generating the cross-packet coded bits.

At 908, the set of cross-packet vertical check block(s) is processed to obtain a set of codewords. For example, the coded bits after rate matching and other typical encoding processes may form a set of codewords.

At 910, the bits of each codeword are scrambled. This further scrambling, following the first scrambling performed at step 904, may be referred to as a second scrambling (or second scrambling stage) or a network coding scrambling (to distinguish from the UE-specific scrambling at step 904). As noted previously, the first scrambling (using the UE-specific identifier) is performed on the information bits before encoding, while the second scrambling (using the network coding identifier) is performed on the coded bits after encoding. The second scrambling is performed using the network coding identifier that is associated with (and specific to) the network coding group to which the first and second destination nodes belongs, and the network coding identifier (e.g., NC-RNTI) is known to the first and second destination nodes. For example, the network coding identifier itself may be used as the scrambling sequence. In another example, the network coding identifier may be used in a function to generate the scrambling sequence (e.g., the scrambling sequence may be a pseudo random sequence that is generated from an initialization seed as a function of the NC-RNTI). The network coding identifier may be a bit sequence, or an integer, which may be generated by the network (e.g., by the BS 170 itself, or another network node), that uniquely identifies the network coding group. In particular, the network coding identifier should not conflict with other identifying sequences (e.g., other C-RNTIs) currently in use. The bits of each codeword may be scrambled by performing an XOR operation with the bits of the scrambling sequence (which may be the network coding identifier itself, or may be a function of the network coding identifier), for example. The result is a set of scrambled codewords.

At 912, a retransmission of the set of cross-packet vertical check block(s) is performed by transmitting the scrambled codewords. For example, the scrambled codewords may be further processed (e.g., modulating, layer mapping, precoding, resource mapping, etc.) and the resulting signal may be transmitted by a transmitter of the source node.

Because the codeword bits have been scrambled using the network coding identifier, which is known to both the first and second destination nodes (and to all UEs configured to the same network coding group), the first and second destination nodes are both able to unscramble and make use of the information in the set of cross-packet vertical check block(s) to aid in their own decoding. However, because the information bits of the first and second TBs are scrambled using respective UE-specific identifiers associated with (and specific to) the first and second destination node, respectively, the first destination node is not able to access the information bits of the second TB and the second destination node is not able to access the information bits of the first TB (i.e., the first destination node does not know the UE-specific identifier associated with the second destination node, and vice versa). In this way, data privacy is preserved.

As mentioned above, the destination nodes that participate in a given network coding group and that are configured to enable unscrambling of bits that have been scrambled using the network coding identifier may be configured semi-statically or dynamically. An example for semi-static configuration of destination nodes for a network coding group is now described.

In semi-static configuration of a network coding group, the multiple UEs 110 that are members of the same network coding group (and that can participate in network coding with each other) are determined in advance (e.g., by a network node, such as the BS 170) and configured semi-statically (e.g., using radio resource control (RRC) signaling). It should be noted that, although the network coding group is configured semi-statically, the members of the network coding group that participate in any network coding-based transmission (e.g., that are destination nodes for a retransmission of cross-packet vertical check block(s)) may be scheduled dynamically and may be only a portion of the network coding group (i.e., not all UEs 110 that have been configured for a given network coding group necessarily participate in each network coding transmission with in the given network coding group).

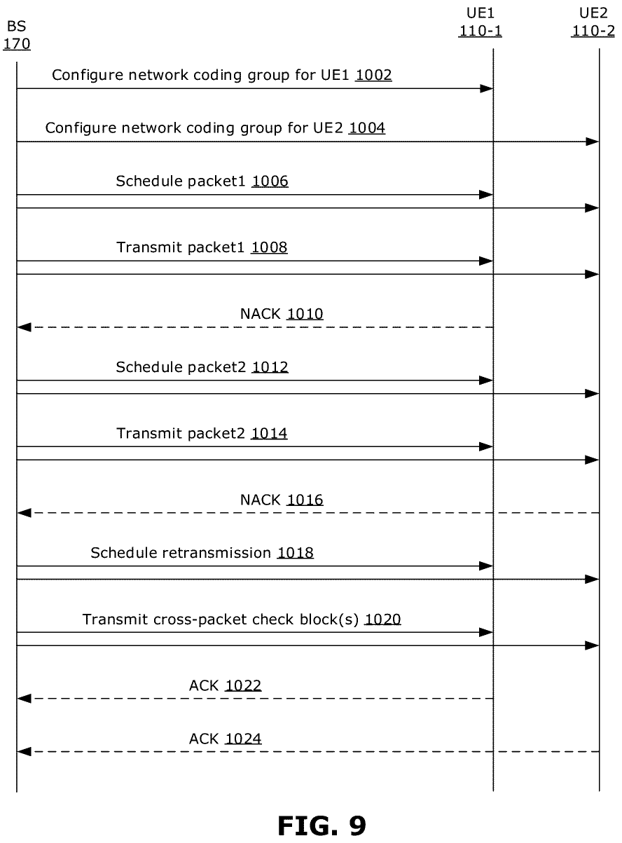

FIG. 9 is a signaling diagram illustrating an example of semi-static configuration of a network coding group for retransmissions. Retransmissions may be performed using any suitable cross-packet coding, such as cross-packet vertical check blocks as described herein. In this example, two-level scrambling is used. In this simplified example, only two UEs 110 (namely UE1 110-1 and UE2 110-2) are shown as participants in the network coding. However, it should be understood that there may be other UEs 110 configured to be members of the same network coding group that do not participate in the network coding shown in this example. Further, it should be understood that the example shown in FIG. 9 may be extended to enable network coding among more than two UEs 110 belonging to the same network coding group.

In this example, the BS 170 sends a respective signal (e.g., RRC signal) to configure the network coding group for UE1 110-1 and UE2 110-2, at transmission 1002 and 1004 respectively. The configuration signaling in this example may be through a higher layer signaling (e.g. RRC) and not through dynamic signaling (e.g. a DCI), thus the configuration may be referred to as a semi-static configuration. The transmissions at 1002 and 1004 may overlap in time (e.g., occur at the same transmission opportunity) over same frequency or different frequency resources or at different times, for example. The configuration information provided at 1002 and 1004 may include the network coding identifier for the network coding group (which is common to and known to all UEs 110 that are members of the same network coding group), which may be referred to as the NC-RNTI. The network coding identifier may be used to scramble the data signal and control signal as described in more detail below.

Additionally, the configuration information transmitted to each UE 110 may include a respective UE index that is assigned to each respective UE 110 belonging to the same network coding group. The UE index may be unique to each UE 110 within the same network coding group, and may be used to identify each UE 110 within the network coding group. In the example shown, the transmission at 1002 may include configuration information including the network coding identifier and UE index 1 assigned to UE1 110-1; and the transmission at 1004 may include configuration information including the same network coding identifier and a different UE index 2 assigned to UE2 110-2. It may be noted that the UE index may be a temporary index, and the UE index assigned to a given UE 110 may change each time the network coding group is semi-statically configured.

It should be noted that the configuration of the UEs 110 for the network coding group (e.g., the transmissions at 1002 and 1004) may occur in advance of any initial transmission or retransmission. For example, UE1 110-1 and UE2 110-2 may be configured for the network coding group even prior to the BS 170 having any data to transmit. Although FIG. 9 illustrates the transmission at 1006 for scheduling packet1 following the transmissions at 1002 and 1004, it should be understood that there may be a prolonged time interval between the transmissions at 1002 and 1004 and the transmission at 1006.

To schedule an initial transmission for a first packet intended for a first destination node (in this example, packet1 intended for UE1 110-1), a group common DCI (i.e., a DCI that is common to and transmitted to all members of a given group) may be transmitted at 1006 to all UEs 110 (in this example, UE1 110-1 and UE2 110-2) that will participate in the network coding-based transmission and retransmission. The group common DCI may be addressed to the intended UEs 110 using the network coding identifier (i.e., the network coding identifier configured earlier). For example, the CRC block of the group common DCI may be scrambled using the network coding identifier itself as a scrambling sequence or using the network coding identifier to generate a scrambling sequence. Optionally and in some scenarios, the network coding identifier may be also used to define the search space of the group common DCI signal. The payload of the group common DCI may include the UE index of the intended destination node (in this example, UE index 1 assigned to UE1 110-1) and other information typically used for scheduling and decode the data (e.g. the time frequency resource used for the transmission, MCS, channel coding information etc.). For example. The UE index may be used, instead of the C-RNTI, to identify the intended destination node within the network coding group. The UE index has been configured earlier in 1002 as described before. The use of the UE index instead of the C-RNTI to identify the intended destination node may reduce the risk of the C-RNTI (which should not be known to any other UE 110) being compromised. Both UE1 110-1 and UE2 110-2 can decode the DCI using the configured network coding identifier. UE1 110-1 and UE2 110-2 may each descramble the CRC of the DCI using the network coding identifier. After the DCI is decoded, UE1 110-1 and UE2 110-2 may each obtain the information in the DCI payload, including the scheduling information for the initial transmission of the first packet as well as the UE index of the intended destination node for the first packet. UE1 110-1 and UE2 110-2 may each use the UE index of the intended destination node to determine whether this first packet is intended for itself.

Following scheduling of the initial transmission for the first packet, the first packet intended for the first destination node (i.e., packet1 intended for UE1 110-1) may be transmitted at 1008 to all UEs 110 participating in the network coding-based transmission. The information bits of the first packet is scrambled using the UE-specific scrambling sequence associated with the first destination node (i.e., UE1 110-1) and the encoded bits are scrambled using the network coding identifier that is known to both UE1 110-1 and UE2 110-2. For example, the method 800 may be performed.

After both UE1 110-1 and UE2 110-2 decode the group common DCI, both UE1 110-1 and UE2 110-2 can obtain the scheduling information and the corresponding initial data transmission. UE1 110-1 and UE2 110-2 can each whether the data is intend for itself by comparing its own UE index to the UE index of the intended destination node. UE1 110-1 can then attempt to decode the data as the data is intended for itself. UE2 110-2 cannot fully decode the data as the information bits are scrambled by the UE-specific identifier associated with UE1 110-1 (e.g. UE1's C-RNTI) that UE2 110-2 does not know.

In a feedback-based transmission scheme, UE1 110-1 may transmit an acknowledgement (ACK) back to the BS 170 if packet1 was successfully decoded, or may transmit a negative acknowledgement (NACK) back to the BS 170 if packet1 was not successfully decoded. For example, as shown in FIG. 9, UE1 110-1 optionally transmits a NACK at 1010 to indicate that packet1 was not successfully decoded. In a NACK-less scheme, UE1 110-1 may only transmit ACK if packet1 was successfully decoded and absence of ACK is recognized by the BS 170 as indicating that packet1 was not successfully decoded. In a blind retransmission scheme, UE1 110-1 may not transmit any feedback to the BS 170 regardless of whether packet1 was successfully or not successfully decoded; the BS 170 may perform a predefined number of transmissions of the same packet without feedback from any destination node.

An initial transmission of a second packet intended for a second destination node (in this example, packet2 intended for UE2 110-2) may be scheduled using another group common DCI at 1012. The group common DCI to schedule the initial transmission of the second packet may be addressed to the UEs 110 participating in the network coding-based transmission using the network coding identifier, as discussed above. Similar to the group common DCI used to schedule the initial transmission of the first packet, the group common DCI for scheduling the initial transmission of the second packet may include the UE index of the intended destination node (i.e., UE index 2 assigned to UE2 110-2) and coding information.

Similarly to the previous discussion, both UE1 110-1 and UE2 110-2 can decode the DCI using the configured network coding identifier. UE1 110-1 and UE2 110-2 may each descramble the CRC of the DCI using network coding identifier. After the DCI is decoded, UE1 110-1 and UE2 110-2 may each obtain the information in the DCI payload, including the scheduling information for the initial transmission of the second packet as well as the UE index of the intended destination node (i.e., UE index 2). Using the UE index of the intended destination node, UE1 110-1 and UE2 110-2 may each determine whether this second packet is intended for itself.

The second packet may then be transmitted at 1014. The second packet is scrambled using the UE-specific identifier associated with the second destination node (i.e., UE2 110-2) and also using the network coding identifier that is known to both UE1 110-1 and UE2 110-2. For example, the method 800 may be performed. Optionally, UE2 110-2 may feedback ACK or NACK (e.g., at 1016) to the BS 170 to indicate successful or unsuccessful decoding of packet2. After both UE1 110-1 and UE2 110-2 decode the group common DCI, both UE1 110-1 and UE2 110-2 can obtain the scheduling information and the corresponding initial data transmission. UE2 110-2 can then attempt to decode the data as it is intended for itself. UE1 110-2 cannot fully decode the data as the information bit is scrambled by the UE-specific identifier associated with UE2 110-2 (e.g. UE2's C-RNTI) that UE1 110-1 does not know.

In the example shown, both UE1 110-1 and UE2 110-2 were not successful in decoding packet1 and packet2, respectively (e.g., as indicated by optional NACKs transmitted at 1010 and 1016). The BS 170 may determine that a retransmission is required. As mentioned above, in some examples the number of retransmissions may be predefined and the BS 170 may determine that a retransmission is required without requiring any feedback from any destination node.

To schedule the retransmission, a group common DCI is transmitted, at 1018, to all UEs 110 participating in the network coding-based retransmission (in this example, UE1 110-1 and UE2 110-2). Similar to the group coding DCIs described above, the group common DCI for scheduling the retransmission may be addressed to UE1 110-1 and UE2 11-2 using the network coding identifier (e.g., the NC-RNTI). The network coding identifier may be used to scramble the CRC of the group common DCI similar to the initial transmission. The DCI payload may include scheduling information for the retransmission (e.g. time frequency resource used for the retransmission), coding information (e.g., modulation and coding scheme (MCS)), an index of the RV, and information about the data packets of the initial transmissions that were used for generating this retransmission. For example, the DCI payload may include a list of the UE indexes and optionally the HARQ process ID for the corresponding packets of the initial transmissions used for generating this retransmission. Information about the corresponding initial transmissions may be required (e.g., the UE indexes of the intended destination nodes corresponding to the initial transmissions), in order for the UEs 110 to identify which packets were used to generate the cross-packet vertical check block(s) in the retransmission (and thus make use of the information in the cross-packet vertical check block(s) to assist in decoding). If there are UEs 110 in the network coding group other than UE1 110-1 and UE2 110-2, and which are configured with the network coding identifier and respective UE index in advance, the other UEs 110 can also decode the DCI using the network coding identifier. However, after the other UEs 110 decode the DCI payload and determine that its own UE index is not in the list of UE index indicating the packets that are used to generate this retransmission, then the other UEs 110 may determine that the DCI as well as the corresponding data transmission is not intended for itself.

A set of one or more cross-packet vertical check block(s) is generated using the first and second packets (packet1 and packet2) and is scrambled using the UE-specific identifiers associated with the respective first and second destination nodes (UE1 110-1 and UE2 110-2), as well as using the network coding identifier. For example, the method 900 may be performed. The cross-packet vertical check block(s) may be transmitted at 1020 to all UEs 110 participating in the network coding-based retransmission (in this example, UE1 110-1 and UE2 110-2).

After decoding the group common DCI sent in 1018, both UE1 110-1 and UE2 110-2 may obtain the scheduling information and can then decode the cross-packet vertical check block(s) using the network coding identifier. Each UE1 110-1 and UE2 110-2 may then combine the decoded cross-packet vertical check block(s) with both initial transmissions to help decode its own packet (i.e., packet1 for UE1 110-1 and packet2 for UE2 110-2) from the initial transmission. It should be noted that if the decoding is successful, each UE 110 can obtain the information bits from its own packet but not the information bits from the packet intended for the other UE 110 because the information bits for each packet are scrambled using the UE-specific identifier of the intended recipient of each packet.

Optionally, UE1 110-1 and UE2 110-2 may transmit respective ACK (at 1022 and 1024) back to the BS 170 to indicate successful decoding of packet1 and packet 2, respectively.

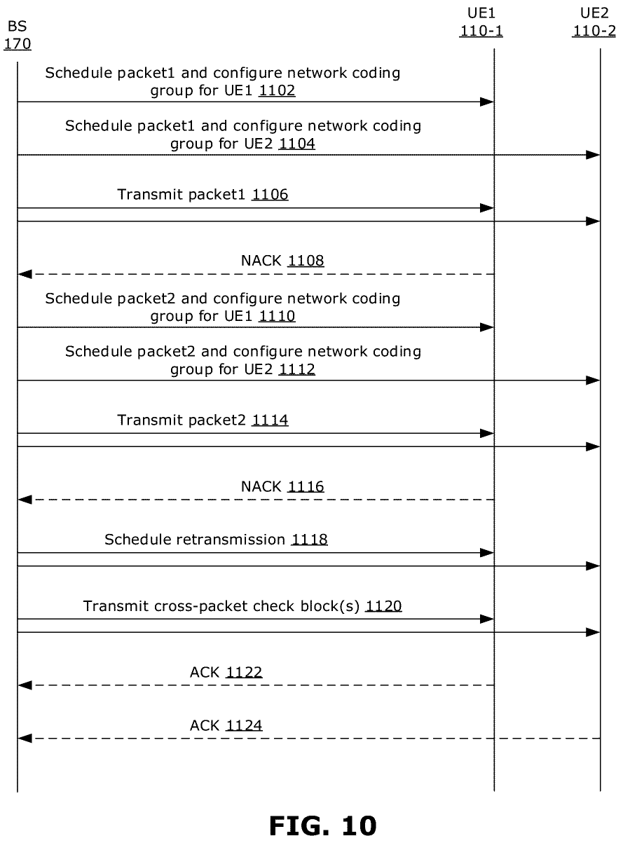

It should be noted that, although FIG. 10 illustrates a certain order for the transmissions, this is not intended to be limiting. For example, some transmissions may be performed asynchronously, may overlap in time, may be performed in a different order, etc.

The present disclosure thus describes a mechanism for semi-static configuration of a network coding group, and for performing network coding-based transmissions and retransmissions with members of the network coding group.

Each UE 110 that has been determined (e.g., by the BS 170) to be a member of the network coding group may be configured for the network coding group using semi-static configuration (e.g., using UE-specific RRC signaling). The members of the network coding group may be predetermined based on any suitable criteria (e.g., geographical proximity, similar channel condition, UEs that share similar data service, etc.). The semi-static configuration information may include the network coding identifier for identifying the network coding group (e.g., NC-RNTI) and the UE index for each UE 110 within the network coding group. The network coding identifier may enable each member of the network coding group to unscramble any data that has been scrambled using the network coding identifier (e.g., where the network coding identifier is itself used as the scrambling sequence to perform the scrambling; or where the network coding identifier is used in a function to generate the scrambling sequence to perform the scrambling).

The control information for an initial transmission may be transmitted in a group common DCI. Alternatively, multiple UE-specific DCIs (not shown in FIG. 9) may be used instead of a group common DCI. The group common DCI for scheduling the initial transmission may include the UE index within the network coding group identifying the intended destination node within the network coding group. Alternatively, if multiple UE-specific DCIs are used, the UE index within the network coding group may be used to identify the intended destination node or each UE-specific DCI may simply indicate (e.g., using a binary flag) whether the UE 110 receiving the UE-specific DCI is (or is not) the intended destination node for the initial transmission. The DCI (group common DCI or UE-specific DCI) may also include typical scheduling information about the initial transmission, such as the time-frequency resource for initial transmission, HARQ process ID, the RV index and the MCS.

The control information for a retransmission may be transmitted in another group common DCI. The group common DCI for scheduling the retransmission may include information about the source packets (or TBs) that were used to generate the cross-packet vertical check block(s) in the retransmission. For example, the group common DCI may include information about the number of UEs and/or packets used for generating the cross-packet vertical check block(s), as well as the UE indexes of the UEs that are the intended destination nodes of the source packets, and the HARQ process IDs of the source packets (e.g., if there are multiple packets intended for the same destination node, the HARQ process ID may be used to identify the specific packet). The group common DCI may also include time frequency resources used for retransmission and information about the parameters used for generating the retransmission, such as information about the interleaver used for generating the cross-packet vertical check block(s) (e.g., the interleaver may be explicitly identified, or may be identified indirectly such as by the RV index associated with the interleaver), and the MCS. Alternatively, multiple UE-specific DCIs (not shown in FIG. 9) may be used instead of a group common DCI.

The semi-static configuration of a network coding group, as disclosed herein, may provide various advantages. For example, the network (e.g., BS 170) may determine the members of the network coding group in advance and may configure the UEs 110 who are members of the network coding group in advance. This may help to reduce the amount of signaling in the dynamic control channel (which may help to reduce congestion in the channel and/or reduce latency). Further, group common DCIs may be used to schedule the initial transmissions, rather than using UE-specific DCIs. This may also help to improve network efficiency (i.e., more efficient use of network resources such as channel bandwidth).

An example for dynamic configuration of destination nodes for a network coding group is now described. In dynamic configuration of a network coding group, the network (e.g., the BS 170) determines which UEs 110 will participate in network coding, without any advanced configuration of the UEs 110. The UEs 110 are configured and scheduled dynamically.

FIG. 10 is a signaling diagram illustrating an example of dynamic configuration of a network coding group for retransmissions. Retransmissions may be performed using any suitable cross-packet coding, such as cross-packet vertical check blocks as described herein. In this example, two-level scrambling is used. In this simplified example, only two UEs 110 (namely UE1 110-1 and UE2 110-2) are shown as participants in the network coding. However, it should be understood that the example shown in FIG. 10 may be extended to enable dynamic configuration of more than two UEs 110 for network coding.

The BS 170 schedules the initial transmission of the first packet intended for the first destination node (in this example, packet1 intended for UE1 110-1) using a UE-specific DCI (at 1102) addressed to the intended destination node (in this example, addressed to UE1 110-1 by using the C-RNTI associated with UE1 110-1 to scramble the CRC block). Because the network coding group was not configured ahead of time, the transmission at 1102 should include information to configure UE1 110-1 for the network coding group, in addition to information for scheduling the initial transmission of packet1. The DCI payload may include configuration information for network coding, such as the network coding identifier (e.g., NC-RNTI) and UE index assigned to UE1 110-1 (e.g., UE index 1); as well as information for scheduling the initial transmission, such as the UE index of the intended destination node (in this example, UE index 1) and other regular scheduling information (e.g., time-frequency and other resources used for the initial transmission, HARQ process ID, RV index, MCS, etc.).

Because all UEs 110 participating in the network coding (in this example, UE1 110-1 and UE2 110-2 are participating in network coding) need to be able to access the same packets, the BC 170 also transmits (at 1104) UE-specific DCIs to each other UE 110 such that the other UEs 110 (in this example, UE2 110-2) participating in the network coding is also configured for network coding and has information to access the packets. For example, the transmission at 1104 may be another UE-specific DCI that is addressed to UE2 110-2 (e.g., using the C-RNTI associated with UE2 110-2), which includes network coding configuration information such as the network coding identifier (e.g., NC-RNTI) and the UE index assigned to UE2 110-2 (e.g., UE index 2); as well as scheduling information for the initial transmission of packet1, such as the UE index of the intended destination node (in this example, UE index 1) and other regular scheduling information (e.g., time-frequency and other resources used for the initial transmission, HARQ process ID, RV index, MCS, etc.).

UE1 110-1 and UE2 110-2 each attempts to decode the UE-specific DCIs (transmitted at 1102 and 1104) using its own UE-specific identifier (e.g. using C-RNTI to descramble the CRC of the UE-specific DCIs). UE1 110-1 is able to decode the UE-specific DCI intended for itself (transmitted at 1102) and UE2 110-2 is able to decode the UE-specific DCI intended for itself (transmitted at 1104). After successfully decoding the UE-specific DCI, UE1 110-1 can attempt to decode subsequent transmission of data packet (e.g., in the initial transmission of the first packet at 1008 described below) that is intended for itself based on information obtained from the UE-specific DCI.

Following scheduling of the initial transmission for the first packet, the first packet intended for the first destination node (i.e., packet1 intended for UE1 110-1) may be transmitted at 1106 to all UEs 110 participating in the network coding-based transmission (i.e., to UE1 110-1 and UE2 110-2 in this example). The first packet is scrambled using the UE-specific identifier associated with the first destination node (i.e., UE1 110-1) and also using the network coding identifier that is known to both UE1 110-1 and UE2 110-2 (e.g., as indicated in the respective UE-specific DCI). For example, the method 800 may be performed.

Using the information from the UE-specific DCIs, UE1 110-1 is able to determine that the first packet is intended for itself. UE1 110-1 may use the network coding identifier (from the UE-specific DCI) to descramble the encoded bits before decoding the channel codes, and may then use its own UE-specific identifier (e.g., C-RNTI) to further descramble the information bits if decoding is successful.

In a feedback-based transmission scheme, UE1 110-1 may transmit an acknowledgement (ACK) back to the BS 170 if packet1 was successfully decoded, or may transmit a negative acknowledgement (NACK) back to the BS 170 if packet1 was not successfully decoded. For example, as shown in FIG. 10, UE1 110-1 optionally transmits a NACK at 1108 to indicate that packet1 was not successfully decoded. In a NACK-less scheme, UE1 110-1 may only transmit ACK if packet1 was successfully decoded and absence of ACK is recognized by the BS 170 as indicating that packet1 was not successfully decoded. In a blind retransmission scheme, UE1 110-1 may not transmit any feedback to the BS 170 regardless of whether packet1 was successfully or not successfully decoded; the BS 170 may perform a predefined number of transmissions of the same packet without feedback from any destination node.

The BS 170 may similarly schedule the initial transmission of the second packet intended for the second destination node (in this example, packet2 intended for UE2 110-2) using UE-specific DCIs that are transmitted to both UE1 110-1 (at 1110) and UE2 110-2 (at 1112). The UE-specific DCIs transmitted at 1110 and 1112 includes the UE index of the intended destination node (in this example, UE index 2) and other regular scheduling information (e.g., HARQ process ID, RV index, MCS, etc.). The UE-specific DCIs transmitted at 1110 and 1112 may also include network coding configuration information, such as the network coding identifier (e.g., NC-RNTI) and the respective UE index assigned to each UE (e.g., UE index 1 is included in the UE-specific DCI for UE1 110-1; UE index 2 is included in the UE-specific DCI for UE2 110-2). In some examples, the network coding configuration information may be omitted from the later-transmitted UE-specific DCIs at 1110 and 1112 as this information is already indicated in the previous-transmitted UE-specific DCIs (at 1102 and 1104) that were used to schedule the initial transmission of the first packet.

UE2 110-2 and UE1 110-1 each attempts to decode the UE-specific DCIs (transmitted at 1110 and 1112) using its own UE-specific identifier (e.g. using C-RNTI to descramble the CRC of the UE-specific DCIs). UE1 110-1 is able to decode the UE-specific DCI intended for itself (transmitted at 1110) and UE2 110-2 is able to decode the UE-specific DCI intended for itself (transmitted at 1112). After successfully decoding the UE-specific DCI, UE2 110-2 can attempt to decode subsequent transmission of data packet (e.g., in the initial transmission of the second packet at 1114 described below) that is intended for itself based on information obtained from the UE-specific DCI.

Following scheduling of the initial transmission for the second packet, the second packet intended for the second destination node (i.e., packet2 intended for UE2 110-2) may be transmitted at 1114 to all UEs 110 participating in the network coding-based transmission (i.e., to UE1 110-1 and UE2 110-2 in this example). The second packet is scrambled using the UE-specific identifier associated with the second destination node (i.e., UE2 110-2) and also using the network coding identifier that is known to both UE1 110-1 and UE2 110-2 (e.g., as indicated in the respective UE-specific DCI). For example, the method 800 may be performed.

Using the information from the UE-specific DCIs, UE2 110-2 is able to determine that the second packet is intended for itself. UE2 110-2 may use the network coding identifier (from the UE-specific DCI) to descramble the encoded bits before decoding the channel codes, and may then use its own UE-specific identifier (e.g., C-RNTI) to further descramble the information bits if decoding is successful.

Optionally, in a feedback-based transmission scheme, UE2 110-2 may transmit a NACK at 1116 to indicate that packet2 was not successfully decoded.

To schedule the retransmission, a group common DCI is transmitted, at 1118, to all UEs 110 participating in the network coding-based retransmission (in this example, UE1 110-1 and UE2 110-2). The DCI may be addressed using the network coding identifier (e.g., the CRC block of the DCI may be scrambled using the NC-RNTI). The DCI payload may include coding information for the retransmission (e.g., MCS), RV index and a list of the UE indexes and optionally HARQ process IDs corresponding to the initial transmission of the source packets (or TBs) that are used to generate the cross-packet vertical check block(s) in the retransmission. Alternatively, separate UE-specific DCIs can be sent to each UE 110 to schedule the retransmission. The separate UE-specific DCIs may contain similar information as that of the group common DCI in the DCI payload.

Both UE1 110-1 and UE2 110-2 may attempt to decode the group common DCI using the network coding identifier (that was obtained from the UE-specific DCIs used to schedule initial transmission). For example, each UE1 110-1 and UE2 110-2 may use the network coding identifier (e.g., NC-RNTI) to descramble the CRC of the group common DCI.

A set of one or more cross-packet vertical check block(s) is generated using the first and second packets (packet1 and packet2). In this example, generating the set of cross-packet vertical check block(s) involves two levels of scrambling. For example, generating the set of cross-packet vertical check block(s) includes first scrambling the information bits of the first and second packets using the UE-specific identifier (e.g. C-RNTI) associated with the respective first and second destination nodes (UE1 110-1 and UE2 110-2), generating the set of cross-packet vertical check block(s) from the scrambled information bits, processing the set of cross-packet vertical check block(s) into codewords and scrambling the codewords using the network coding identifier (e.g. NC-RNTI). For example, the method 900 may be performed. The cross-packet vertical check block(s) may be transmitted at 1120 to all UEs 110 participating in the network coding-based retransmission (in this example, UE1 110-1 and UE2 110-2). Using information obtained from the group common DCI (transmitted at 1118), UE1 110-1 and UE2 110-2 can each obtain the codewords of the cross-packet vertical check block(s) by unscrambling using the network coding identifier. Then UE1 110-1 and UE2 110-2 can each use the cross-packet vertical check block(s) along with both encoded packets from the initial transmissions to perform joint decoding. If decoding is successful, UE1 110-1 and UE2 110-2 can each recover its own information bits by descrambling the scrambled information bits using its own UE-specific identifier (e.g. C-RNTI). However, since UE1 110-1 and UE2 110-2 each does not have access to the other UE's UE-specific identifier, UE1 110-1 and UE2 110-2 cannot unscramble the information bits that are intended for the other UE (i.e., UE1 110-1 cannot unscramble the information bits intended for UE2 110-2, and vice versa).

Optionally, UE1 110-1 and UE2 110-2 may transmit respective ACK (at 1122 and 1124) back to the BS 170 to indicate successful decoding of packet1 and packet 2, respectively.

It should be noted that, although FIG. 10 illustrates a certain order for the transmissions, this is not intended to be limiting. For example, some transmissions may be performed asynchronously, may overlap in time, may be performed in a different order, etc.

The present disclosure thus describes a mechanism for dynamic configuration of a network coding group and scheduling of network coding-based transmissions and retransmissions.

Each UE 110 that participates in the network coding-based transmission and retransmission is dynamically configured using UE-specific DCIs to carry control information for the initial transmission and to carry network coding information. For example, the information carried in the UE-specific DCI may include information indicating that a physical layer network coding scheme is to be used (e.g., indicated by a specific DCI format, or by the presence of the network coding identifier (e.g. NC-RNTI)), as well as network coding configuration information such as the network coding identifier (e.g., NC-RNTI) and the UE index for the specific UE 110 within the network coding group. The network coding identifier may enable each member of the network coding group to unscramble any data that has been scrambled using the network coding identifier (e.g., where the network coding identifier is itself used as the scrambling sequence to perform the scrambling; or where the network coding identifier is used in a function to generate the scrambling sequence to perform the scrambling). Additionally, the UE-specific DCI may include information for the initial transmission, such as the UE index identifying the intended destination node within the network coding group (or alternatively a simple indicator whether the UE 110 receiving the UE-specific DCI is the intended destination node for the initial transmission, for example if there are only two UEs 110 involved in the network coding). The UE-specific DCI may also include typical scheduling information such as the time-frequency and other resource used for the initial transmission, HARQ process ID, the RV index and the MCS for the initial transmission.

The control information for a retransmission may be transmitted in a group common DCI. Alternatively, multiple UE-specific DCIs (not shown in FIG. 10) may be used instead of a group common DCI. The control information for the retransmission may include a new data indicator (NDI) that is a fixed value (e.g. 1, instead of being toggled for retransmission) indicating the control information is for a retransmission instead of an initial transmission. As the retransmission may corresponds to multiple initial transmissions, it may be ambiguous to compare the NDI value of the retransmission to the NDI value of the initial transmission to decide whether it is toggled. The group common DCI for scheduling the retransmission may include information about the source packets (or TBs) that were used to generate the cross-packet vertical check block(s) in the retransmission. For example, the group common DCI may include information about the number of UEs and/or packets used for generating the cross-packet vertical check block(s), as well as the UE indexes of the UEs that are the intended destination nodes of the source packets, and optionally the HARQ process IDs of the source packets (e.g., if there are multiple packets intended for the same destination node, the HARQ process ID may be used to identify the specific packet). The group common DCI may also include information about the parameters used for generating the retransmission, such as time-frequency and other resources used for the retransmission of the data, information about the interleaver used for generating the cross-packet vertical check block(s) (e.g., the interleaver may be explicitly identified, or may be identified indirectly such as by the RV index associated with the interleaver), and the MCS, etc.

The dynamic configuration of a network coding group, as disclosed herein, may provide various advantages. For example, the network (e.g., the BS 170) may define the network coding group with greater flexibility, for example using more updated information (e.g., if UEs 110 are highly mobile). Further, there is no need for additional signaling for semi-statically configuring the network coding group.

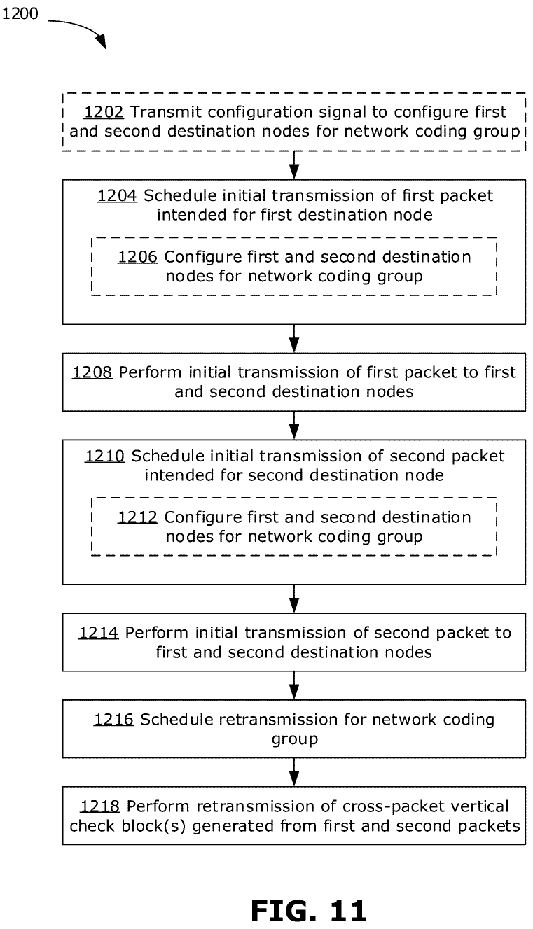

FIG. 11 is a flowchart illustrating an example method 1200 that may be performed by a network node (e.g., the BS 170) for configuring a network coding group and performing network coding-based (re) transmissions. The example method 1200 is described with respect to configuring network coding for first and second destination nodes (e.g., first and second UEs 110), however it should be understood that this is only for simplicity and more than two destination nodes may be configured for network coding in the same network coding group. It should be noted that although the method 1200 describes the use of cross-packet vertical check block(s) for performing the retransmission, other techniques for cross-packet coding may be used instead to generate cross-packet coded bits for retransmission.

Optionally, at 1202, configuration signals may be transmitted to configure the first and second destination nodes for the network coding group. The configuration signals may be transmitted to semi-statically configure the first and second destination nodes for the network coding group (e.g., as shown in the example of FIG. 9). For example, the BS 170 may transmit a configuration signal (e.g., RRC signal) to the first destination node that includes a network coding identifier (e.g., NC-RNTI) identifying the network coding group and a node index (e.g., UE index) that identifies the first destination node within the network coding group. Similar information may be included in the configuration signal transmitted to the second destination node, except that the second destination node is provided with the node index that identifies the second destination node within the network coding group.

At 1204, an initial transmission of a first packet that is intended for the first destination node is scheduled. The scheduling may be performed by transmitting a dynamic communication (e.g., in the downlink control channel) to the first and second destination nodes. If the first and second destination nodes have been semi-statically configured for network coding (at step 1202), the initial transmission of the first packet may be scheduled using a group common DCI that is addressed using the network coding identifier.

If the first and second destination nodes have not been configured for network coding (step 1202 is not performed), then the initial transmission of the first packet may be scheduled using UE-specific DCIs for each of the first and second destination nodes (e.g., as shown in the example of FIG. 10), and scheduling the initial transmission may include configuring each of the first and second destination nodes for the network coding group (at optional step 1206). Each of the first and second destination nodes may be provided with network coding configuration information (e.g., including the network coding identifier (e.g., NC-RNTI) identifying the network coding group; and a node index (e.g., UE index) that identifies the destination node of the data packet within the network coding group).

Thus, if the network coding configuration information is not provided prior to step 1204, then the network coding configuration information is provided as part of step 1204. In other words, the method 1200 includes transmitting configuration information to configure the first and second destination nodes for the network coding group. The configuration information may be transmitted as a configuration signal (e.g., RRC signal) to semi-statically configure the first and second destination nodes, or may be transmitted as part of scheduling the initial transmission.

At 1208, the initial transmission of the first packet to the first and second destination nodes is performed. Performing the initial transmission may include scrambling the information bits using the UE-specific identifier associated with the first destination node, performing processing to generate codewords, scrambling the bits of the codewords using the network coding identifier, processing the result into a signal and transmitting the signal (e.g., as described with respect to FIG. 7).

At 1210, an initial transmission of a second packet that is intended for the second destination node is scheduled. The scheduling may be performed by transmitting a dynamic communication (e.g., in the downlink control channel) to the first and second destination nodes. Similar to step 1204, if the first and second destination nodes have been semi-statically configured for network coding (at step 1202), the initial transmission of the second packet may be scheduled using a group common DCI that is addressed using the network coding identifier. If the first and second destination nodes have not been configured for network coding (step 1202 is not performed), then the initial transmission of the second packet may be scheduled using UE-specific DCIs for each of the first and second destination nodes (e.g., as shown in the example of FIG. 10), and scheduling the initial transmission may include configuration each of the first and second destination nodes for the network coding group (at optional step 1212).

In some examples, if the network coding configuration information was not transmitted at step 1202 but was included in the information scheduling the initial transmission of the first packet (e.g., at 1204 and 1206), then it may not be necessary to provide the network coding configuration information again when scheduling the initial transmission of the second packet, and optional step 1212 may be omitted, as well the initial transmission of the second packet may be scheduled using a group common DCI addressed using the network coding identifier instead of using UE-specific DCIs. In other examples, if the network coding configuration information was not transmitted at step 1202, step 1210 may be performed in the same manner as step 1204 (i.e., both steps 1204 and 1210 are performed using UE-specific DCIs and include network coding configuration information as well as control information for the respective initial transmissions in the UE-specific DCIs), regardless of whether the network coding configuration information was already included in a previous UE-specific DCI.

At 1214, the initial transmission of the second packet to the first and second destination nodes is performed. Performing the initial transmission may include scrambling the information bits using the UE-specific identifier associated with the second destination node, performing processing to generate codewords, scrambling the bits of the codewords using the network coding identifier, processing the result into a signal and transmitting the signal (e.g., as described with respect to FIG. 7).

Although the method 1200 illustrates steps for scheduling and performing the initial transmission of the first packet followed by steps for scheduling and performing the initial transmission of the second packet, it should be understood that this is not intended to be limiting.

After the initial transmissions of the first packet and the second packet, a determination may be made that one or more retransmissions are required. For example, negative feedback (e.g., NACK) may be received from one or both of the first and second destination nodes indicating that the first or second packet, respectively, was not successfully decoded. In another example, absence of positive feedback (e.g., ACK) may indicate a failure to successfully decode the first or second packet. In another example, determining that a retransmission is required may include determining whether a predefined number of one or more retransmissions has been performed (with feedback or in the absence of feedback). Assuming that at least one retransmission is required, the method 1200 proceeds to step 1216.

At 1216, a retransmission is scheduled for the network coding group, including the first and second destination nodes. The scheduling may be performed by transmitting a dynamic communication addressed to the network coding group (e.g., using a group common DCI that is addressed using the network coding identifier, such as using the NC-RNTI to scramble the CRC block of the group common DCI). As described above, the control information for the retransmission may include information that identifies the source packets (or TBs) that were used to generate the cross-packet vertical check block(s) in the retransmission (e.g., the node index of the destination node for each source packet, and optionally the HARQ process ID for each source packet), as well as information about the parameters used for generating the cross-packet vertical check block(s) in the retransmission.

At 1218, the retransmission is performed to transmit a set of one or more cross-packet vertical check block(s), generated from the first and second packets, to the first and second destination nodes. Performing the retransmission may include first generating the set of one or more cross-packet vertical check block(s), which involves two levels of scrambling as discussed previously (e.g., using the method 900). Further, the set of one or more cross-packet vertical check block(s) may be generated in accordance with predefined parameters (e.g., using a predefined interleaver).

Multiple retransmissions may be scheduled and performed, until no longer required (e.g., until the predefined number of retransmissions has been satisfied, or until positive feedback has been received from both the first destination node and the second destination node to indicate successful decoding of the respective first packet and second packet).

In various examples, the present disclosure has described methods and apparatuses that may be used for performing retransmissions in network coding. A two-level scrambling mechanism, which includes the use of a network coding identifier (which may be referred to as NC-RNTI) in addition to the use of a UE-specific identifier (which may be C-RNTI), is described. Information that should be accessible to all members of network coding group is scrambled using the network coding identifier, whereas information that should be kept private is scrambled using the UE-specific identifier that is specific to the intended destination node. Thus, data privacy may be preserved at the same while benefiting from the efficiency advantages associated with retransmissions using cross-packet vertical check block(s).

The present disclosure has also described example mechanisms for semi-statically or dynamically configuring destination nodes for the network coding group. In particular, the present disclosure has described the used of semi-static or dynamic configuration for providing individual destination nodes with network coding configuration information (e.g., including the network coding identifier) to configure the destination nodes for the network coding group. The network coding configuration information that is used to configure a given destination node may also include a node index (e.g., UE index) that can be used to identify the given destination node within the network coding group, instead of using the C-RNTI. The node index may also be used, when scheduling a retransmission, to identify the source packets used to generate the cross-packet vertical check block(s) for the retransmission.

In the present disclosure, examples have been described in which a group common DCI, which is addressed using the network coding identifier (e.g., NC-RNTI), is used to schedule (re) transmissions. In some examples, multiple UE-specific DCIs, addressed to each destination node using the C-RNTI of each destination node, may be used instead of the group common DCI. The payload of the UE-specific DCIs may be similar to the payload of the group common DCI. The use of multiple UE-specific DCIs may introduce more signaling overhead compared to the use of the group common DCI; on the other hand, the use of multiple UE-specific DCIs may provide advantages, for example, each UE-specific DCI may be decoded and recognized by the respective destination node with greater certainty.

The present disclosure has described the use of the network coding group and network coding identifier in the context of two-level scrambling (i.e., together with scrambling using a UE-specific identifier). However, it should be understood that the network coding group and network coding identifier (such as NC-RNTI) may be used independently of the two-level scrambling mechanism. For example, the network coding identifier may be used to scramble bits with or without additional scrambling using a UE-specific identifier.

The present disclosure has described the use of the network coding group and network coding scrambling sequence in the context a 2D HARQ retransmission scheme (i.e., retransmissions that include cross-packet vertical check blocks). The two-level scrambling mechanism and the semi-static or dynamic configuration of the network coding group, as disclosed herein, may be applicable to other network coding schemes including those that do not use 2D HARQ. For example, another network coding scheme may perform retransmissions where, instead of using cross-packet vertical check blocks, XOR or a linear combination of the information bits in different packets (or TBs) is used to produce a new network coding information packet for retransmission. The UE-specific identifier may be used to scramble the information bits of the packets and the network coding identifier may be used to scramble the encoded codewords in a two-level scrambling mechanism.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

What is claimed is:

1. A method, at a network node, comprising:
obtaining a first packet intended for a first destination node and a second packet intended for a second destination node;
performing an initial transmission of the first packet to the first and second destination nodes, and performing an initial transmission of the second packet to the first and second destination nodes; and
performing a retransmission to the first and the second destination nodes, wherein performing the retransmission includes generating cross-packet coded bits using a combination of one or more bits from the first packet and one or more bits from the second packet, wherein the cross-packet coded bits are scrambled using an identifier known to both the first destination node and the second destination node, and wherein the cross-packet coded bits, after scrambling, are used for the retransmission.

2. The method of claim 1, wherein generating the cross-packet coded bits comprises generating a set of one or more cross-packet check blocks using the one or more bits from the first packet and one or more bits from the second packet.

3. The method of claim 1, wherein the first destination node and the second destination node are configured for network coding in a given network coding group, wherein the cross-packet coded bits are scrambled using a network coding identifier associated with the given network coding group, the network coding identifier being the identifier known to both the first destination node and the second destination node.

4. The method of claim 3, wherein the cross-packet coded bits are scrambled using a scrambling sequence that is a function of the network coding identifier.

5. The method of claim 3, wherein the first and the second destination nodes are provided configuration information for network coding in the given network coding group, the configuration information including the network coding identifier associated with the given network coding group.

6. The method of claim 5, further comprising:
scheduling the retransmission, wherein scheduling the retransmission includes providing control information to the first and second destination nodes, the control including the first and second node indexes as indicators that the first and second packets are source packets for the retransmission, and
wherein the control information for scheduling the retransmission is transmitted to the first and the second destination nodes using a group common downlink control information (DCI) transmission, and wherein the group common DCI is addressed to the given network coding group using the network coding identifier.

7. The method of claim 5, further comprising:
transmitting configuration signals to provide the first and the second destination nodes with the configuration information for network coding in the given network coding group; and
subsequent to transmitting the configuration signals, scheduling the initial transmission of the first packet and scheduling the initial transmission of the second packet.

8. The method of claim 7, wherein the configuration signals are radio resource control (RRC) signals transmitted to the respective first and second destination nodes, and control information for scheduling the initial transmission of the first packet and for scheduling the initial transmission of the second packet are transmitted in group common downlink control information (DCI) transmissions addressed to the given network coding group using the network coding identifier.

9. The method of claim 5, further comprising:
scheduling the initial transmission of the first packet and scheduling the initial transmission of the second packet, wherein the configuration information to configure the first and the second destination nodes for network coding in the given network coding group are included in control information for scheduling the initial transmissions.

10. The method of claim 9, wherein the control information for scheduling the initial transmission of the first packet and for scheduling the initial transmission of the second packet are transmitted in user equipment (UE)-specific downlink control information (DCI) transmissions addressed to each of the first and the second destination nodes, wherein the configuration information to configure the first destination node for network coding in the given network coding group is included in the UE-specific DCI transmission addressed to the first destination node using a UE identifier of the first destination node, and wherein the configuration information to configure the second destination node for network coding in the given network coding group is included in the UE-specific DCI transmission addressed to the second destination node using a UE identifier of the second destination node.

11. The method of claim 1, wherein, prior to generating the cross-packet coded bits, the bits from the first packet are scrambled using a UE-specific identifier associated with the first destination node and the bits from the second packet are scrambled using a UE-specific identifier associated with the second destination node, and wherein the cross-packet coded bits are generated using the scrambled bits from the first packet and the scrambled bits from the second packet.

12. The method of claim 1, wherein performing the initial transmission of the first packet comprises:
generating a set of codewords for the first packet;
scrambling the set of codewords for the first packet using the network coding identifier; and
transmitting the scrambled set of codewords for the first packet in the initial transmission of the first packet;
wherein performing the initial transmission of the second packet comprises:
generating a set of codewords for the second packet;
scrambling the set of codewords for the second packet using the network coding identifier; and
transmitting the scrambled set of codewords for the second packet in the initial transmission of the second packet.

13. The method of claim 12, wherein performing the initial transmission of the first packet further comprises:
scrambling information bits of the first packet using a UE-specific identifier associated with the first destination node; and
processing the scrambled information bits of the first packet to generate the set of codewords for the first packet;
wherein performing the initial transmission of the second packet further comprises:
scrambling information bits of the second packet using a UE-specific identifier associated with the second destination node; and
processing the scrambled information bits of the second packet to obtain the set of codewords for the second packet.

14. A method, at a destination node, comprising:
receiving an initial transmission of a first packet intended for the destination node, the initial transmission including scrambled codewords for the first packet, wherein the scrambled codewords for the first packet are scrambled using a network coding identifier associated with a network coding group for which the destination node is configured;
unscrambling the initial transmission of the first packet using the network coding identifier to unscramble the codewords for the first packet and attempting to recover information bits of the first packet;
receiving an initial transmission of a second packet intended for a different destination node, the initial transmission including scrambled codewords for the second packet, wherein the scrambled codewords for the second packet are scrambled using a network coding identifier associated with a network coding group for which the destination node is configured;
unscrambling the initial transmission of the second packet using the network coding identifier;
receiving a retransmission including cross-packet coded bits generating from a combination of one or more bits from the first packet and one or more bits from the second packet; and
unscrambling the retransmission using the network coding identifier, and using the cross-packet coded bits to assist in recovery of the information bits of the first packet.

15. The method of claim 14, further comprising:
after unscrambling the initial transmission of the first packet using the network coding identifier, attempting to decode the codewords for the first packet and unscrambling the information bits of the first packet using a user equipment (UE)-specific identifier associated with the destination node.

16. The method of claim 14, further comprising:
prior to receiving the initial transmission of the first packet and receiving the initial transmission of the second packet, receiving configuration information including the network coding identifier.

17. The method of claim 16, further comprising:
receiving control information for scheduling the initial transmission of the first packet in a group common downlink control information (DCI) transmission addressed to the network coding group using the network coding identifier; and
receiving control information for scheduling the initial transmission the second packet in another group common DCI transmission addressed to the network coding group using the network coding identifier.

18. The method of claim 16, wherein the configuration information is received in control information for scheduling the initial transmission of the first packet, wherein the control information for scheduling the initial transmission of the first packet is received in a UE-specific downlink control information (DCI) transmission addressed to the destination node.

19. An apparatus comprising a processing unit configured to cause the apparatus to:
obtain a first packet intended for a first destination node and a second packet intended for a second destination node;
perform an initial transmission of the first packet to the first and second destination nodes, and perform an initial transmission of the second packet to the first and second destination nodes; and
perform a retransmission to the first and the second destination nodes, by generating cross-packet coded bits using a combination of one or more bits from the first packet and one or more bits from the second packet, wherein the cross-packet coded bits are scrambled using an identifier known to both the first destination node and the second destination node, and wherein the cross-packet coded bits, after scrambling, are used for the retransmission.

20. An apparatus comprising a processing unit configured to cause the apparatus to:
receive an initial transmission of a first packet intended for the destination node, the initial transmission including scrambled codewords for the first packet, wherein the scrambled codewords for the first packet are scrambled using a network coding identifier associated with a network coding group for which the destination node is configured;
unscramble the initial transmission of the first packet using the network coding identifier to unscramble the codewords for the first packet and attempt to recover information bits of the first packet;
receive an initial transmission of a second packet intended for a different destination node, the initial transmission including scrambled codewords for the second packet, wherein the scrambled codewords for the second packet are scrambled using a network coding identifier associated with a network coding group for which the destination node is configured;
unscramble the initial transmission of the second packet using the network coding identifier;
receive a retransmission including cross-packet coded bits generating from a combination of one or more bits from the first packet and one or more bits from the second packet; and
unscramble the retransmission using the network coding identifier, and use the cross-packet coded bits to assist in recovery of the information bits of the first packet.
